(19) United States
(12) Patent Application Publication
(10) Pub. No.: US 2013/0127263 A1
(43) Pub. Date: May 23, 2013

(54) WASHER WASHING BALL INDUCTIVE DEVICE AND A DRAIN COVER FOR THE WASHING BALLS

(71) Applicant: Ho Yong Park, Wonju-si (KR)

(72) Inventor: Ho Yong Park, Wonju-si (KR)

(21) Appl. No.: 13/509,024

(22) PCT Filed: Nov. 5, 2010
(86) PCT No.: PCT/KR10/07813

§ 371 Date: Jun. 27, 2012

(30) Foreign Application Priority Data
Nov. 10, 2009 (KR) 10-2009-0107916
Jan. 22, 2010 (KR) 20-2010-0000759
Feb. 2, 2010 (KR) 10-2010-0009467
Aug. 3, 2010 (KR) 10-2010-0075074

(51) Int. Cl. H02K 57/00; B08B 3/04

(52) U.S. Cl. CPC H02K 57/006; B08B 3/04
USPC 310/10

(57) ABSTRACT

Disclosed are a washing unit for washing contaminants within a washing machine, a permanent magnet inducing unit for effectively washing an inner wall of a water tank by using induction of an electric field or providing a motion to an artificial floating body of the water tank, and a drain cover for a washing machine for assisting a washing operation of a washing ball of the washing machine. The washing unit has a body for maintaining a certain shape such as a ball and a plurality of washing projections, and is introduced into spaces between the water container and the washing tub and between the water tank and the pulsator to frictionally remove various filths attached to the washing tank, the washing tub and the pulsator with the washing projections that floats at a predetermined depth of washing water.

### TECHNICAL FIELD

The present invention relates to a washing ball for washing a water container, a washing tub, and a water flow guide of a washing machine.

More particularly, the present invention relates to an induction apparatus for washing inner walls of a water container, a washing tub, and a water flow guide or providing a motion to a washing ball within a space between the water container and the washing tub or a space between the washing tub and the water flow guide.

The present invention also relates to a drain cover which can prevent a washing ball for performing a washing operation between a washing tub and a water container from being discharged together with washing water so that the washing ball can be reused and can smoothly discharge hair, threads, other foreign substances such as coins or buttons, and washing water.

### BACKGROUND ART

As a washing machine is used for a long time, filth, such as remnants of cloth or hair, which comes from the laundry, is stacked in a space between a water container and a washing tub of the washing machine.

Most users disassemble and wash a washing machine generally at a time interval of four to five years, or resolve liquid washing detergents in washing water and idle the washing water to remove the filth.

However, since a considerable level of mechanics technology is required to disassemble and wash a washing machine, it is a big burden for an ordinary person to directly disassemble and wash the washing machine and service businesses for doing this dedicatedly are booming. Thus, a fee should be paid to receive the service, which is a considerable economical burden.

In addition, a method of washing a washing machine using a liquid detergent does not require the special knowledge relatively so that an ordinary person can easily wash a washing machine, but old dirt or dirty filth cannot be washed sufficiently, which is not satisfactory.

In order to solve the above problems, attempts for providing an interior washing function to a washing machine have been suggested.

Korean Unexamined Patent Publication No. 2009-0023804 (Prior Art 1) relates to a washing machine employing an automatic washing apparatus, which includes a first washing brush installed on an inner wall of a water container of a washing machine, a second washing brush installed on an outer wall of a drum of the washing machine, and a third washing brush installed in a drum housing on the bottom of the water container, in order to automatically wash an interior of the washing machine during a washing operation of the washing machine.

Korean Unexamined Patent Publication No. 2007-0088212 (Prior Art 2) relates to a washing machine and a method of washing a detergent supply mechanism, which includes a washing tub installed within a cabinet and having a water supply passage and a water discharge passage, a detergent supply mechanism communicated with one side of the water supply passage to supply a detergent into the washing tub, and a steam generator having a water supply opening connected to an opposite side of the water supply passage to supply water steam and having a steam discharge opening connected to the detergent supply mechanism and the washing tub to supply steam.

Korean Registered Patent Publication No. 0698304 (Prior Art 3) relates to a method of washing a washing tub of a drum washing machine, which includes selecting a washing mode of a washing tub, supplying washing water to a steam generating apparatus, turning on a heater of the steam generating apparatus to heat washing water, and injecting steam into the washing tub for a predetermined time period to sterilize the washing tub.

However, according to Prior Art 1, since artificial members such as washing brushes are mounted in a washing machine, a smooth operation of the washing machine may be obstructed by the washing brushes and relatively high costs and efforts should be paid to replace an old washing brush.

In addition, since Prior Arts 2 and 3 generate steam to wash an interior of a washing machine, artificial energy is necessary to generate steam for washing the washing machine.

These problems are similarly applied to a water container, a water tank, and a large-sized fish tank which cannot be directly contacted by a hand of a human being, in addition to a washing machine.

Meanwhile, since one or more water supplying processes and water discharging processes should be actually repeated to wash a washing machine by using a washing ball, the following problems need to be solved to smoothly perform the processes.

That is, since there is provided no foreign substance filtering drain cover used in a general drain in a drain of the washing machine, a plurality of washing balls may be discharged to the outside through the drain or a smooth discharging operation is obstructed when the washing balls gather in the drain at once. Since a desired washing effect cannot be expected with one washing operation of the washing machine, if the washing balls are discharged to the outside when a plurality of washing operations are performed, it is necessary to supply the washing balls in each washing process into the washing machine, which is bothersome. Further, if smooth discharge of the washing water is obstructed by the washing balls, the washing time becomes longer and the following water supplying operation is performed while the washed contaminant materials are not properly discharged, causing washing efficiency to be reduced.

### DISCLOSURE

### Technical Problem

The present invention has been made in an effort to provide a non-powered washing unit which can effectively wash an interior of a washing machine without using an artificial washing structure.

The present invention also provides a washing unit having a structure which can be easily introduced into and extracted from an interior of a washing machine.

The present invention also provides a set of washing units which can effectively wash an interior of a washing machine with different physical characteristics.

The present invention also provides a permanent magnet inducing unit for effectively washing an inner wall of a water tank by using induction of an electric field or providing a motion to an artificial floating body of a water tank.

The present invention also provides a drain cover which can prevent washing balls from being discharged to the outside of a washing machine in a water draining process.

The present invention also provides a drain cover structure which can smoothly drain water even when washing balls and a plurality of foreign substances gather at a portion of the drain cover.

The present invention also provides an auxiliary unit which allows washing balls concentrated at a portion of a drain cover to easily escape the portion of the drain cover in a water supplying process.

### Technical Solution

In order to solve these problems, the present invention suggests a washing ball for a washing machine, including a body maintaining a predetermined buoyancy to be influenced by a flow of washing water and a plurality of washing projections attached to an outer side of the body to frictionally contact a washing tub and a water container and remove filth.

According to an aspect of the present invention, there is provided a set of washing balls, including a first washing ball having a first body maintaining a first specific gravity higher than a gravity of washing water to be influenced by a flow of the washing water and a plurality of washing projections attached to an outer side of the first body, and a second washing ball having a second body maintaining a second specific gravity higher than a gravity of washing water and different from the first specific gravity and a plurality of washing projections attached to an outer side of the second body.

According to another aspect of the present invention, there is provided an apparatus for inducing a floating body provided therein with a permanent magnet and located within a water tank. The inducing apparatus includes a plurality of coil windings mounted to an outer surface of the water container, and a pattern forming circuit for applying a pulse signal of a predetermined pattern to the coil windings to generate an electric field for inducing the floating body within the water container.

According to still another aspect of the present invention, there is provided a drain cover, including: a semispherical main body 20, and a fixing body for mounting the main body 20 to a drain of a washing machine, wherein a plurality of circular drain holes having a first diameter and a plurality of filter member type drain holes.

According to yet another aspect of the present invention, there is provided a drain cover, including: a filter frame 40 formed to have a rectangular drawer shape, and a receiving body 50 for receiving the filter frame 40 to fix the filter frame 40 such that the filter frame 40 is located on a drain of a washing machine, wherein a filter member 41 inclined at a predetermined angle is formed inside the filter frame 40 to face each other.

Here, the drain cover may further include a magnetic body inducting unit 60 including a frame 62 having a solenoid coil 61 therein, and a bracket 63 for fixing the frame 62 to a predetermined location of the washing machine, wherein the magnetic body inducing unit 60 is spaced apart from an upper portion of the receiving body 50 by a predetermined distance.

### Advantageous Effects

According to a washing ball of the present invention, since a water tank, a washing tub and a pulsator can be washed without disassembling a washing machine, laundry can be prevented from being contaminated by fungi or germs within the washing machine. That is, since the washing ball of the present invention cleans an interior of a washing machine while moving according to a rotating water flow of washing water by itself, it is regarded as an eco-friendly and economical washing unit which does require neither separate drive energy nor washing water. In addition, since the washing ball is realized by a small-sized ball or a similar shape, the washing tub and the water tank can be washed while the washing ball freely moves in a narrow space between the washing tub and the water container. In particular, since the washing ball freely passes through an L-shaped inner part bent from a lower end portion of the space, it can even wash a part which cannot be reached by a conventional linear washing brush.

According to another exemplary embodiment, even a point which cannot be reached by a hand of a user can be effectively washed by using a washing ball having a permanent magnet therein and a permanent magnet inducing unit.

According to still another exemplary embodiment, a washing ball cannot be discharged through a drain of a washing machine, it is unnecessary to compensate washing balls even when a washing process is repeated several times. In addition, since a maximum draining space can be secured due to the drain cover structures of the exemplary embodiment even when washing balls and a plurality of foreign substances are concentrated near a drain, the washing water can be drained promptly. Furthermore, since the washing balls near the drain can smoothly escape from the drain, the following washing operation can be effectively performed.

### DESCRIPTION OF DRAWINGS

FIGS. 1 and 2 are views illustrating a washing principle of washing balls according to the present invention;

FIGS. 3 to 7 are cut-away views for explaining a structure of washing balls according to exemplary embodiments of the present invention;

FIG. 8 is a view illustrating a washing operation in the case where three types of washing balls are provided according to weight bodies;

FIGS. 9 and 10 are views illustrating washing balls according to other exemplary embodiments of the present invention;

FIG. 11 is a view illustrating a different type of washing operation of a washing ball of the present invention;

FIGS. 12 to 14 are views illustrating various examples of water containers to which a plurality of coil windings are mounted;

FIG. 15 is a view illustrating an example of a pattern forming circuit;

FIG. 16 is a view schematically illustrating a signal pattern according to T1 and T2;

FIG. 17 is a view schematically illustrating a waveform of a signal produced with magnitudes of T3 and T4;

FIG. 18 is a view illustrating the signal pattern of FIG. 16 and the signal pattern of FIG. 17 which are sequentially generated;

FIGS. 19 and 20 are views illustrating the movement of washing balls in sections where a washing motor is rotated clockwise and counterclockwise;

FIG. 21 is a view illustrating a modified example of a signal generator in the pattern forming circuit of FIG. 15;

FIGS. 22 to 25 are views illustrating other examples of pattern forming circuits;

FIGS. 26 to 28 are views illustrating examples of pulse signals generated by a microcomputer 8051;

FIG. 29 is a view illustrating an example of a drain cover according to a first exemplary embodiment of the present invention;

FIG. 30 is a view illustrating that the drain cover according to the first exemplary embodiment of the present invention is mounted to a drain of a washing machine;

FIG. 31 is a view illustrating an example of a drain cover according to a second exemplary embodiment of the present invention;

FIG. 32 is a view separately illustrating a filter frame in the drain cover according to the second exemplary embodiment of the present invention;

FIG. 33 is a view illustrating a principle of receiving a filter frame in the drain cover according to the second exemplary embodiment of the present invention;

FIG. 34 is a side view for explaining a structure for mounting the drain cover according to the second exemplary embodiment of the present invention to a washing machine;

FIG. 35 is a view illustrating that blocking steps are formed around a drain cover;

FIG. 36 is a view illustrating an example of a filter frame according to a third exemplary embodiment of the present invention;

FIG. 37 is a view illustrating another example of a filter frame according to the third exemplary embodiment of the present invention;

FIGS. 38 and 39 are side views for explaining an operational principle of a filter frame; and

FIG. 40 is a view schematically illustrating an interior structure of a washing ball constituted by an independent power source body.

### BEST MODE

### Mode for Invention

Hereinafter, exemplary embodiments of the present invention will be described in more detail with reference to the accompanying drawings so that those skilled in the art to which the present invention pertains can easily carry out the invention. However, the present invention is not limited to the below-described exemplary embodiments, but may be implemented in various different forms. The parts irrelevant to the description of the present invention will be omitted in the drawings to clearly describe the present invention, and the same or like reference numerals will be used to describe the same or like elements throughout the specification.

Throughout the specification, when it is described that a part includes an element, it means not that other elements are excluded from the part but the part may further include other elements unless specifically described otherwise.

Throughout the specification, a specific gravity refers to a ratio of a unit weight of a certain object to a unit weight of water which is a weight of water when the temperature of water is 4 degrees Celsius. Further, buoyancy refers to a force opposite to a gravitational force applied from a fluid to a stationary object in the fluid when the gravity is applied to the object. Thus, if a specific gravity of an object becomes smaller than 1 which is the specific gravity of water, a buoyancy of the object becomes larger, whereas if a specific gravity of an object becomes smaller than 1 which is the specific gravity of water, a buoyancy of the object becomes smaller.

Since washing water contains various sanitizers, detergents, and contaminants as compared with pure water and a normal temperature of washing water is generally higher than 4 degrees Celsius, a gravity of washing water may be somewhat smaller than 1. Thus, when a gravity of washing water is A, gravities of washing balls are designed as B which is larger than A by a predetermined value in the exemplary embodiments of the present invention.

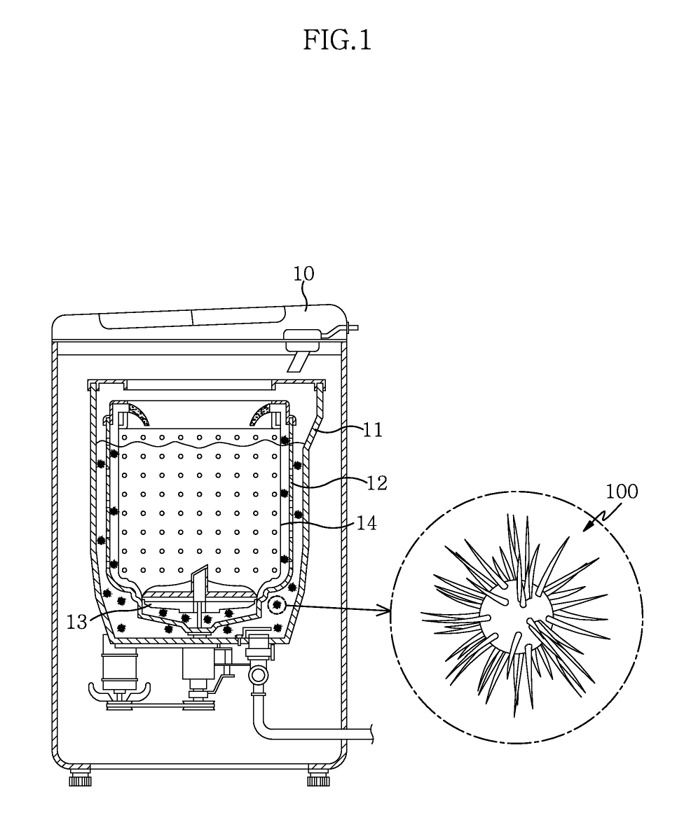

FIG. 1 is a view illustrating a washing principle of a washing ball according to the present invention.

First, a structure of a general washing machine 10 into which a washing ball 100 of the present invention is inserted will be described.

As illustrated in FIG. 1, a water container 11 for containing washing water is installed in an interior space of a cabinet forming an outer appearance of the washing machine 10, a pulsator 13 connected to a motor is installed at a lower end of an interior of the water container 11 to form a vortex flow of the washing water, and a washing tub 12 for containing laundry is rotatably installed within the water container 11. A water flow guide 14 may be further installed within the washing tub 12. Spaces of several centimeters to several tens of centimeters is generally formed between the water container 11 and the washing tub 12 and between the washing tub 12 and the water flow guide 14 and a plurality of holes are formed in the washing tub 12 and the water flow guide 14 so that washing water can freely introduced or discharged through the holes to allow the water container 11, the washing tub 12 and the water flow guide 14 to maintain the same water level.

The principle of operating the washing ball 100 in the structure of the washing machine 10 will be described below.

The washing ball 10 is inserted into spaces formed between the water container 11 and the washing tub 12 of the washing machine 10 and between the washing tub 12 and the water flow guide 14. As washing water is supplied, the washing ball 100 floating at a predetermined depth of the washing water is dynamically moved according to a rotating water flow generated by an operation of the pulsator 13 to remove filth attached to outer surfaces of the water container 11, the washing tub 12 and the water flow guide 14 by using frictions.

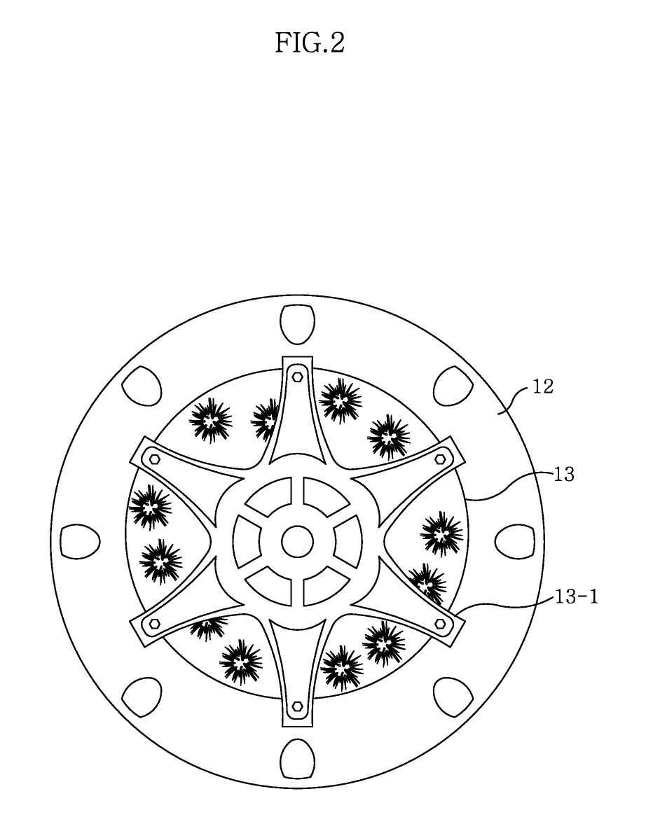

Meanwhile, the pulsator 13 of the washing machine is generally formed of a plastic material, and serves to transfer a rotating force of a motor to the washing water to generate a strong rotating water flow, so the pulsator 13 needs to secure durability. Thus, metallic reinforcing bosses 13-1 are additionally mounted to a lower end surface of the pulsator 13 to reinforce durability thereof, in which case a large amount of contaminants are generated in a narrow space between the pulsator 13 and the water container 11 but cannot be easily washed. FIG. 2 illustrates an internal lower end structure of the washing machine.

The washing ball 100 reaches a space between the pulsator 13 and a bottom surface of the water container 11 while being dynamically moved according to a rotating water flow. Then, the washing ball 100 frictionally contacts and removes filth attached to the corresponding space while being moved due to a storing rotation of the pulsator 13.

If the pulsator 13 is manufactured by a metallic material to secure durability by nature, members such as reinforcing bosses will not be necessary, and thus a space between the pulsator 13 and the bottom surface of the water container 100 can be further widened. In this case, since the washing ball can enter into or exit from the corresponding space, contaminants can be removed more clearly.

In order to effectively wash filth, the washing ball 100 needs to maintain proper buoyancy, and various exemplary embodiments on how to maintain a buoyancy of the washing ball 100 will be suggested as follows.

<First Exemplary Embodiment of Washing Ball>

In the first exemplary embodiment, an interior of the washing ball is classified into an outer layer and an inner layer, and the inner layer is realized by a specific material member for maintaining a buoyancy of the washing ball.

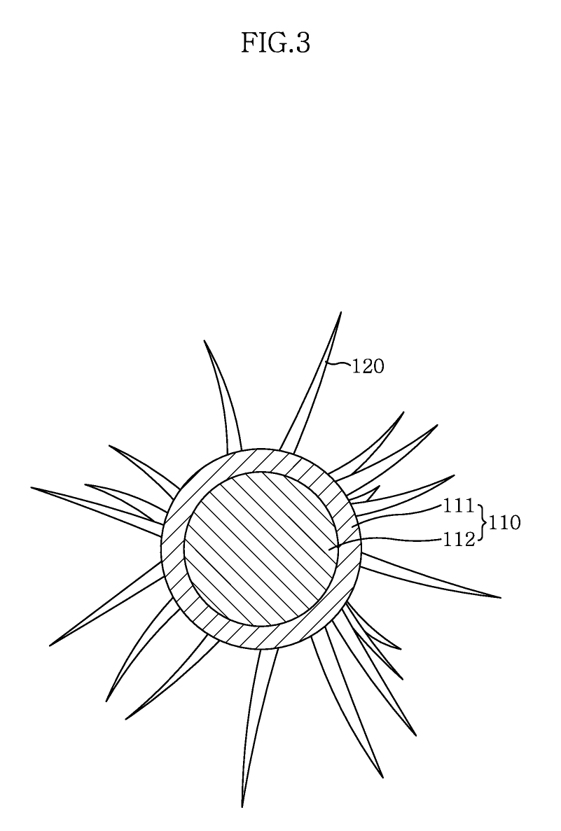

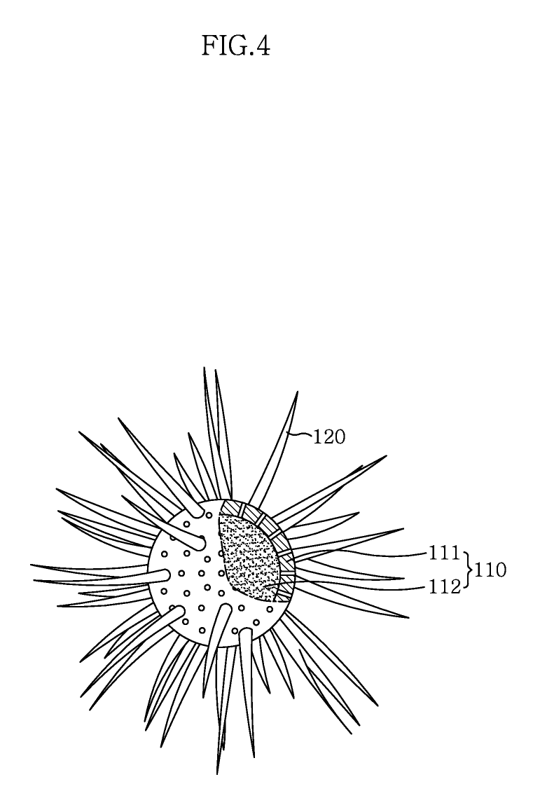

FIGS. 3 and 4 are cutaway views for explaining a structure of a washing ball according to the first exemplary embodiment of the present invention.

As illustrated in FIGS. 3 and 4, the washing ball 100 according to the first exemplary embodiment includes a body 110 for maintaining the predetermined buoyancy so that the washing ball 110 can float at a predetermined depth of washing water and a plurality of washing projections 120 attached to an outer side of the body 110. The body 110 is classified into an outer layer 111 to which the washing projections 120 are attached and an inner layer 112 located inside the outer layer 111 to maintain a specific gravity of the washing ball 100 larger than that of water.

The outer layer 111 is preferably made of a plastic material such as a thermoplastic resin or a thermosetting resin or a ceramic material to prevent deformation of an outer appearance of the water ball 100 due to a long term use thereof, but is not limited thereto. The outer layer 111 may be formed of any material securing a durability of the outer layer 111 at a lever of plastic or ceramic.

The outer layer 111 and the washing projections 120 may be manufactured through injection molding, in which case since the washing projections 120 are preferably formed of a soft material to be prevented from damaging an outer surface of a washing tub, the outer layer 111 is also preferably formed of a soft material (for example, a plastic material). In addition, the outer layer 111 may be formed of a hard material (for example, a ceramic material) for maintenance of an outer appearance of the washing ball 100 and other objects, and soft washing projections 120 may be bonded to the outer layer 111.

Meanwhile, as illustrated in FIG. 3, the inner layer 112 may be formed of a specific material to control a specific gravity of the washing ball 100. Since various materials have different specific gravities, a member of a proper material needs to be selected to maintain the buoyancy designed in advance. The material may be a solid such as wood, plastic, or a metal, or a liquid such as water or a mixture of water and another material (for example, salty water or soda water).

As illustrated in FIG. 4, in another example, the inner layer 112 may be a porous member such as sponge or memory foam to adjust a specific gravity of the washing ball 100.

When a porous member is used as the inner layer 112, a plurality of punch holes are formed on the outer layer 111 such that washing water can freely introduced into or discharged from the inner layer 112 through the outer layer 111.

Since sponge of the inner layer 112 as an example of the porous member contains only air before washing water is supplied into the water container 11, a specific gravity of the washing ball 100 is a value C smaller than A. Thus, at an initial time point when washing water starts to be supplied into the water container 11, the washing ball 100 floats on the water surface of the washing water due to a high buoyancy of the washing ball 100.

However, as the sponge gradually absorbs washing water, a specific gravity of the washing ball 100 gradually approaches B, and by the time when the washing water reaches a full water level of the water container 11, the buoyancy of the washing ball 100 is reduced to a degree corresponding to the specific gravity B, floating at a predetermined depth below the water surface.

Thereafter, if a rotating water flow is generated in the washing water due to an operation of the pulsator 13 of the washing machine, the washing ball 100 is dynamically moved along the rotating water flow and the washing projections 120 of the washing ball 100 frictionally contacts the water container 11 and the washing tub 12, removing the filth attached to here and there.

<Second Exemplary Embodiment of Washing Ball>

In the second exemplary embodiment, an interior of the washing ball is classified into an outer layer and an inner layer, the inner layer is realized by a specific material member for maintaining a buoyancy of the washing ball, and a weight body for adjusting a buoyancy of the washing ball is further provided at the center of the inner layer.

The second exemplary embodiment may be utilized to correct a predesigned buoyancy, which cannot be adjusted by the porous member of the corresponding raw material, with a weight body when a type of the raw material to be used as the porous member of the inner layer is restricted, considering easiness of securing the raw material or costs of the raw material, or to provide the washing balls having various buoyancies according to existence of the weight bodies or the types of weight bodies as a set product.

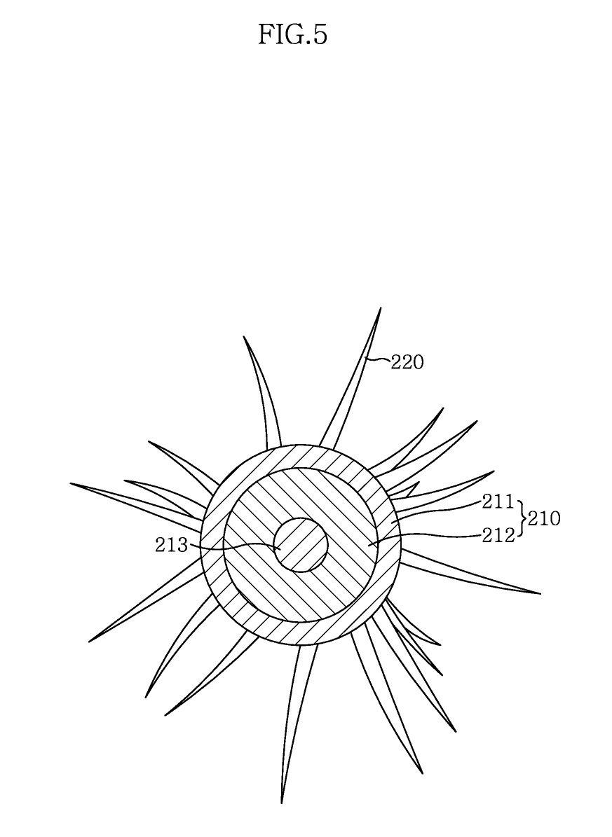

FIG. 5 is a cutaway view for explaining a structure of the washing ball according to the second exemplary embodiment.

As illustrated in FIG. 5, the washing ball 200 of the second exemplary embodiment includes a body 210 maintaining a predetermined buoyancy such that the washing ball 200 floats at a predetermined depth of the washing water and a plurality of washing projections 220 attached to an outside of the body 210, and the body 210 is in turn classified into an outer layer 211 to which washing projections are attached and an inner layer 212 located inside the outer layer 211 to maintain a specific gravity of the washing ball 200 larger than that of water. A weight body 213 for adjusting a buoyancy of the washing ball 200 is further provided at the center of the inner layer 212.

The configurations of the outer layer 211 and the inner layer 212 of the body 210 are the same as the outer layer 111 and the inner layer 112 of the first exemplary embodiment, and the weight body 213 will be additionally described here.

The weight of the weight body 213 is set such that a specific gravity of the washing ball 200 is matched with a predesigned value, considering the case where the inner layer 212 absorbs washing water maximally. In this case, the predesigned specific gravity may be one or plural. The types of weight bodies 213 need to be variously provided to correspond to the number of weight balls 213 to design the specific gravity of the washing ball 200 to be plural.

The weight body 213 is adapted only to adjust a specific gravity of the washing ball 200, and the material or shape of the weight body 213 is not limited specifically. Thus, a solid material such as a metal or ceramic may be used as the weight body 213 and a liquid material may also be used.

<Third Exemplary Embodiment of Washing Ball>

In third second exemplary embodiment, an interior of the washing ball is classified into an outer layer and an inner layer, and the inner layer is realized by a magnetic member for maintaining a buoyancy of the washing ball and retrieving the washing ball. If a material of the inner layer is not a magnetic, a material of the weight body additionally provided at the center of the inner layer may be realized by a magnetic.

The third exemplary embodiment may be utilized to form the inner layer or the central weight body of the washing ball with a magnetic material member and pull out the washing ball by using a washing ball retrieving rod having a magnetic material or steel material retrieving portion at one side thereof as a measure for retrieving the washing ball after a washing operation when the washing tub and the water container are washed by introducing only the washing ball without using washing water to exclude a possibility of contaminating laundry with filth with a washing operation of the washing ball.

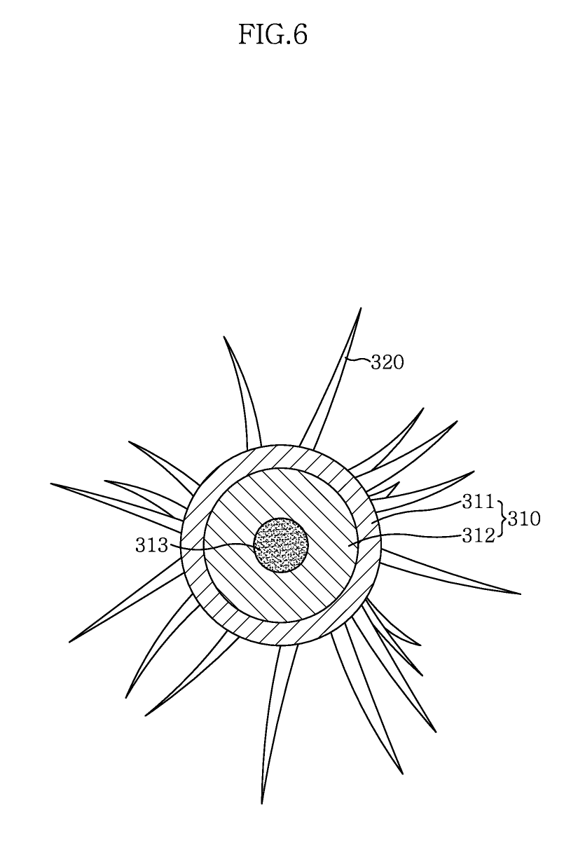

FIG. 6 is a cutaway view for explaining a structure of the washing ball according to the third exemplary embodiment.

As illustrated in FIG. 6, the washing ball 300 of the third exemplary embodiment includes a body 310 maintaining a predetermined buoyancy to float at a predetermined depth of washing water and a plurality of washing projections 320 attached to an outer side of the body 310, and the body 310 is in turn classified into an outer layer 311 to which the washing projections are attached and an inner layer 312 located inside the outer layer 311 to maintain a specific gravity of the washing ball 300 larger than that of water.

The configurations of the outer layer 311 and the inner layer 312 of the body 310 are the same as the outer layer 111 and the inner layer 112 of the first exemplary embodiment. However, the inner layer 312 not only serves to maintain a buoyancy of the washing ball 300 but also can be easily retrieved by the retrieving rod 350 when the water ball 300 is retrieved from the washing machine by forming the inner layer 312 of a magnetic material. The buoyancy maintaining function of the inner layer 312 is as described in the first and second exemplary embodiments.

A central weight 313 of a magnetic material may be further provided at the center of the inner layer 312. The central weight 313 not only helps the retrieving rod 350 easily retrieve the washing ball 300 when the washing ball 300 is retrieved from the washing machine but also serves to adjust a buoyancy of the washing ball 300. The buoyancy adjusting function of the central weight 313 may be replaced by the description of the weight body 213 of the second exemplary embodiment.

<Fourth Exemplary Embodiment of Washing Ball>

The fourth exemplary embodiment relates to a washing ball having only a body and washing projections. A material maintaining a buoyancy of the washing ball at a predesigned level is used as a material of the body or a material of the body and the washing projections to simplify a water ball manufacturing process.

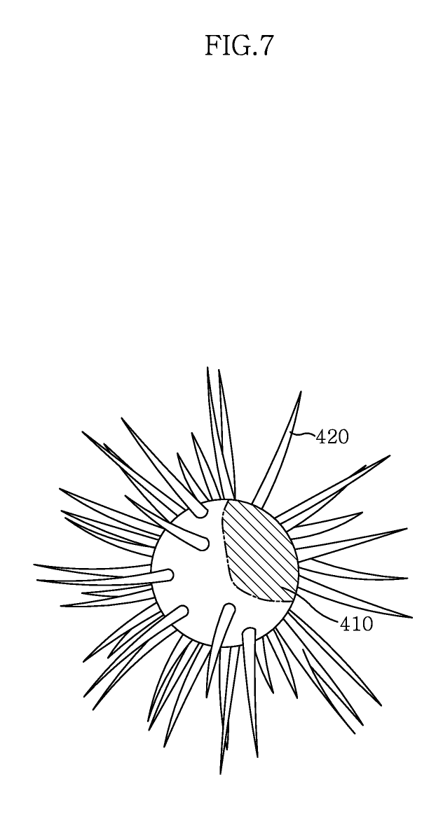

FIG. 7 is a cutaway for explaining a structure of the washing ball according to the fourth exemplary embodiment.

As illustrated in FIG. 7, the washing ball 400 of the fourth exemplary embodiment includes a body 410 maintaining a predetermined buoyancy to float at a predetermined depth of washing water and a plurality of washing projections 420 attached to an outer side of the body 410.

The description of the body 410 and the washing projections 420 are the same as the description of the body 110 and the washing projections 120 of the first exemplary embodiment, but a material maintaining a buoyancy of the washing ball at a predesigned level is used as a material of the body or a material of the body and the washing projections.

<Fifth Exemplary Embodiment of Washing Balls>

In the fifth exemplary embodiment, a plurality of washing balls are introduced into one washing machine and the plurality of washing balls are classified into two more groups according to magnitudes of buoyancies.

To this end, the washing balls 100 of the first exemplary embodiment may be classified into two or more groups according to buoyancies by making the materials of the inner layers 112 different, and the washing balls 200 of the second exemplary embodiment may be classified into two or more groups according to buoyancies by making the materials of the inner layers 212 and/or the weight body 213 different. Further, in the washing balls 300 of the third exemplary embodiment, the materials of the inner layers 312 and/or the central weight 313 may be made different, and in the washing balls 400 of the fourth exemplary embodiment, the materials of the bodies 410 and the washing projections 420 may be made different.

Here, a case of varying the materials of the weight bodies 213 of the second exemplary embodiment and classifying the washing balls 200 into three groups will be described by utilizing a representative example of the fifth exemplary embodiment. This can be easily induced by those skilled in the art from the descriptions of the first, third, and fifth exemplary embodiments as well as the second exemplary embodiment.

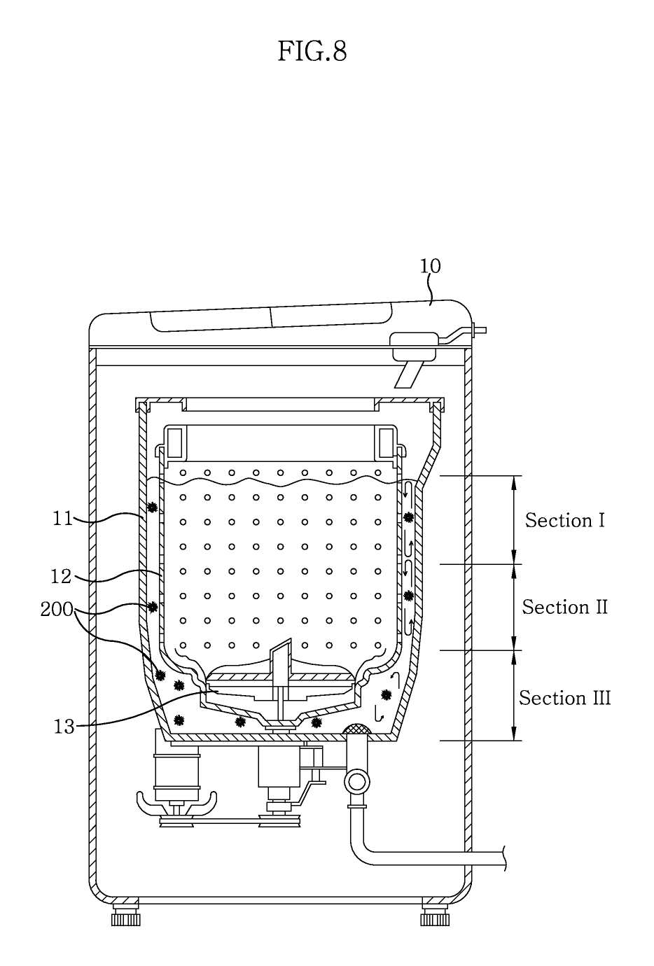

For convenience' sake, it will be exemplified that a specific gravity of washing water is A, a specific gravity of the washing ball a without a weight body is a (here, a>A), a specific gravity of the washing ball b having a weight body m is b (here, b>a>A), and a specific gravity c having a weight body n is c (here, c>b>a>A). FIG. 8 illustrates a washing operation when three types of washing balls are provided according to weight bodies.

The specific gravities of the washing balls a to c are different, and the washing balls a to c float at three depths if the washing water reaches a full water level of the water container 11. In the example of FIG. 4, the washing balls a floats at a high level of the washing water, the washing ball b floats at a middle level of the washing water, and the washing ball c is positioned on a bottom layer of the washing water.

In this state, if a rotating water flow is generated in the washing water by an operation of the pulsator 13 of the washing machine, the washing projections 220 of the washing ball frictionally contacts the water container 11 and the washing tub 12 while the washing balls a to c are dynamically moved according to the rotating water flow, removing the filth attached to here and there. Here, the washing ball a is moved mainly in section I by a buoyancy of the specific gravity a, the washing ball b is moved mainly in section II by a buoyancy of the specific gravity b, and the washing ball c is moved mainly in section III (or near the bottom) by a buoyancy of the specific gravity c while removing filth.

When washing balls have the same buoyancy, movement range of the washing balls are too wide, lowering washing efficiency. Accordingly, the fifth exemplary embodiment is a modified example for improving the problem.

<Sixth Exemplary Embodiment of Washing Ball>

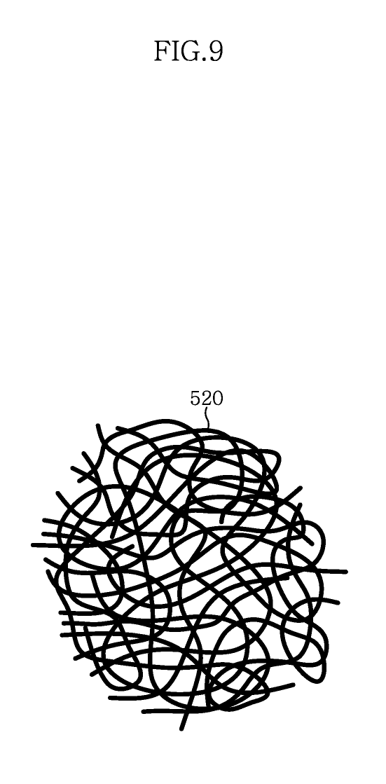

The sixth exemplary embodiment relates to a washing ball using acryl yarns as washing projections. FIG. 9 illustrates an example of the washing ball of the sixth exemplary embodiment.

The washing ball 500 of the sixth exemplary embodiment includes a body (not shown) and acryl yarn washing projections 520. The configuration of the body is the same as those of the washing balls of the first to fourth exemplary embodiments, and only the washing projections 520 will be described here.

Acryl yarns refer to threads formed of a acryl material. When the washing projections 520 are formed of acryl yarns, the washing projections 520 provide an excellent washing effect to the washing tub and the water container due to the antifungal (or sterilizing) characteristics of acryl yarns.

If a acryl yarn is enlarged, since a plurality of polymeric recesses are formed on a surface thereof, the acryl yarn shows the characteristics of removing oil components stronger than other materials. That is, the polymeric recesses of the acryl yarn easily absorb oil components due to the capillary phenomenon and the principle of osmosis. The main components of the filth attached to the washing tub and the water container are oils, and the washing effects can be doubled by using the washing projections 520 of the acryl yarn.

In the washing ball 600 of the sixth exemplary embodiment, a plurality of acryl yarns may be attached to the body by using a bonding means or by stitching the yarns on skin of the body.

<Seventh Exemplary Embodiment of Washing Ball>

The seventh exemplary embodiment relates to a disposable washing ball.

In the washing balls of the first to sixth exemplary embodiments, since the washing projections 120, 220, 320, 420 and 520 are gradually worn out by frictions with filth over time, the washing balls 100, 200, 300, 400 and 500 should be replaced finally.

The seventh exemplary embodiment has been conceived from the aspect, and suggests a washing ball which is resolved in the washing water to disappear. The washing ball (not shown) of the seventh exemplary embodiment may be resolved after one use of the washing ball, but is not necessarily limited thereto and may be resolved after several or several tens of uses of the washing ball. Thus, the term ‘disposable’ in the specification not only refers to a one-use purpose but refers to a purpose for use in a relatively short time.

The washing ball of the seventh exemplary embodiment may be produced by mixing starch with at least one of fiber powder (for example, starch powder), gelatin, and an abrasive. Accordingly, the washing ball of the seventh exemplary embodiment has softness to polish and washing the filth on the outer walls of the water container 11 and the washing tub 12 without damaging the outer walls. The water ball is gradually resolved in the washing water to disappear while performing several or several tens of washing operations.

After adding at least one of fiber starch, gelatin, and an abrasive to starch, the mixture is kneaded with water. The kneaded mixture is steamed first, and is press-molded by using a pre-manufactured molding die. An empty space corresponding to the body and the washing projections is formed in advance inside the molding die. Thereafter, the press-molded mixture is steamed secondarily at a high temperature, and is gradually cooled and hardened. If the hardened mixture is dried, the washing ball of the seventh exemplary embodiment is manufactured. In the washing ball of the seventh exemplary embodiment, the body and the washing projections are formed at once, and there is no process of attaching the washing projections.

Meanwhile, in the first to seventh exemplary embodiments, the bodies 110, 210, 310, 410 and 510 of the washing balls 100, 200, 300, 400 and 500 are realized by spherical shapes, but the present invention is not limited thereto and may be realized by any polyhedral shape such as the tetrahedral, hexahedra, or octahedral shape.

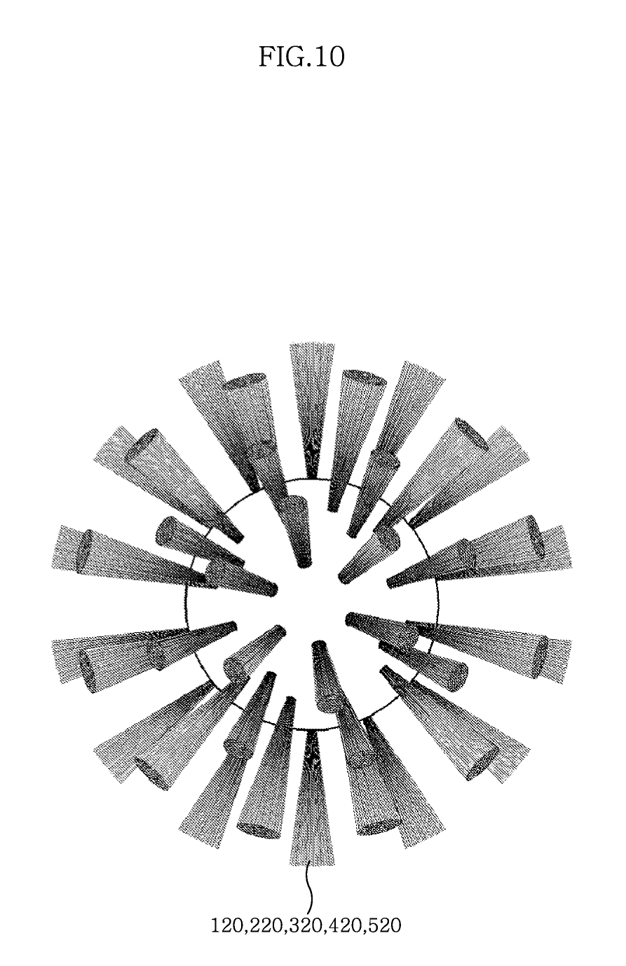

Further, in the first to seventh exemplary embodiments, the washing projections 120, 220, 320, 420 and 520 are realized by conic shapes, but the present invention is not limited thereto and may be realized by brush shapes as illustrated in FIG. 10.

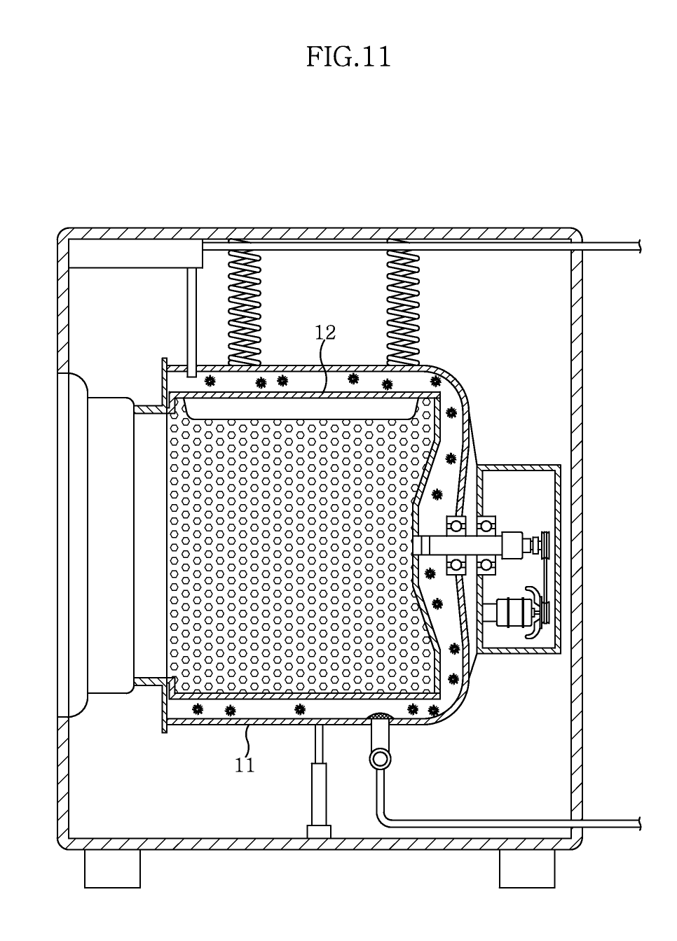

In addition, the first to seventh exemplary embodiments, the washing balls 100, 200, 300, 400 and 500 are operated in a general washing machine, the present invention may be applied to a drum washing machine as illustrated in FIG. 11, and the washing balls 100, 200, 300, 400 and 500 of the present invention may be applied to a washing machine where a space is provided between a washing tub and a water container.

<Example of Mounting Coil Windings of Washing Ball Inducing Apparatus>

FIGS. 12 to 14 suggest various examples of water containers to which a plurality of coil windings are mounted.

At least one winding support for fixing a plurality of coil windings C20 is formed in or mounted to the water container 11.

In the example of FIG. 12, the winding support may be realized by a shape where two support shafts 14a and one winding shaft 14b are connected to each other. The coil windings C20 occupy the considerable volume, and a portion 11a of the water container 11 to which the winding support is mounted is preferably designed to be recessed inward. End wires of the coil windings C20 are connected to pattern forming circuits.

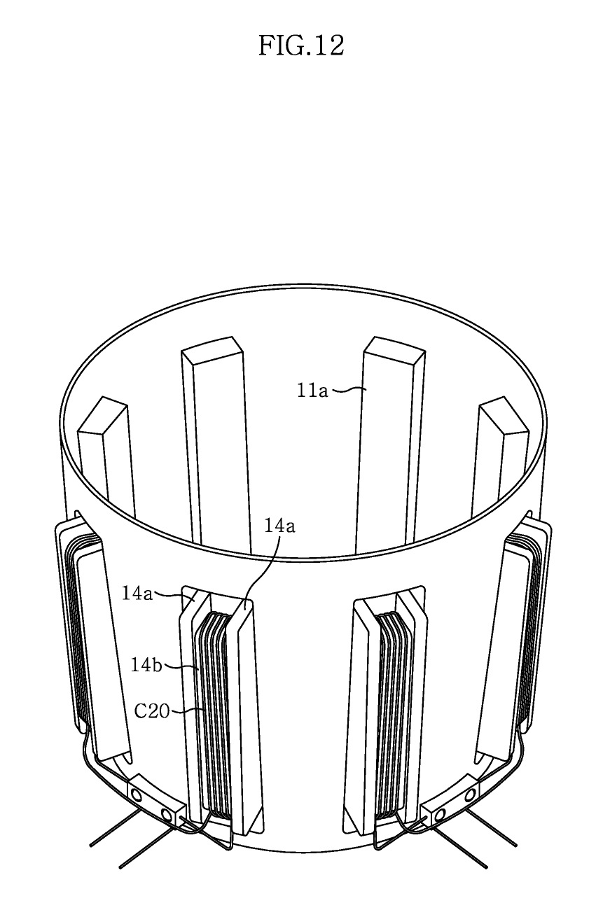

An example of FIG. 13 does not separately illustrate a winding support (not shown in FIG. 2) and only illustrates a shape where coil windings C20 are wound. In FIG. 13, the winding support may be realized by a shape where one support shaft (not shown in FIG. 13) and one winding shaft (not shown in FIG. 13) are connected to each other.

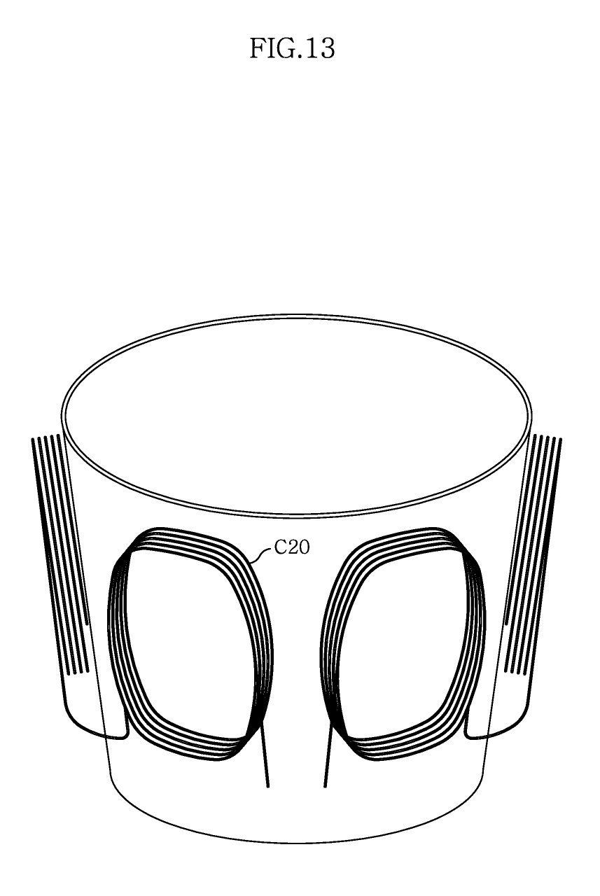

An example of FIG. 14 illustrates a case where four winding supports in which two support shafts 14a and one winding shaft 14b are connected to each other to form a dumb-bell shape are provided for one set of coil windings C20. One set of coil windings C20 is classified into left group A and a right group B, and in group A and group B, the winding directions of the coil windings C20 are different from each other. In the example of FIG. 14, a total of four sets of coil windings C20 are mounted to the water container 11, and the winding directions of the coil windings C20 of facing groups of adjacent coil windings C20 are different from each other.

The water tanks of FIGS. 12 to 14 may be realized by a water tank of a washing machine, a water reservoir tank, and an electronic fish tank. Hereinafter, a water tank of a washing machine will be exemplified to help understanding of the present invention. It is assumed that a washing ball where washing projections are attached to an outer surface of a body floats at a predetermined depth as a floating body having a permanent magnet therein between a water tank and a washing tub of a washing machine.

<Configuration of Pattern Forming Circuit provided in Washing Ball Inducing Apparatus>

Next, a pattern forming circuit for applying a signal having a predetermined pattern to coil windings C20 of FIGS. 12 to 14 to form an electric field for inducing the washing ball will be described.

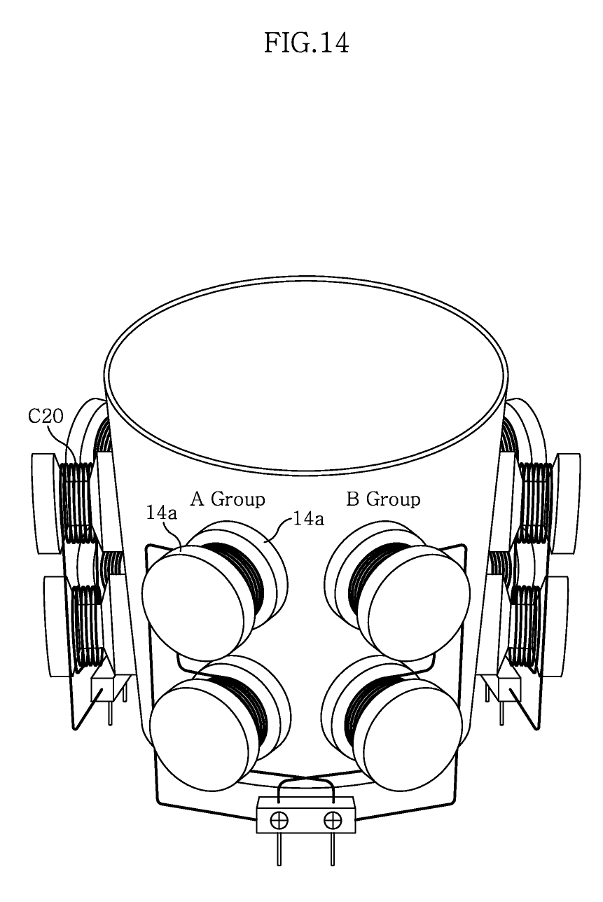

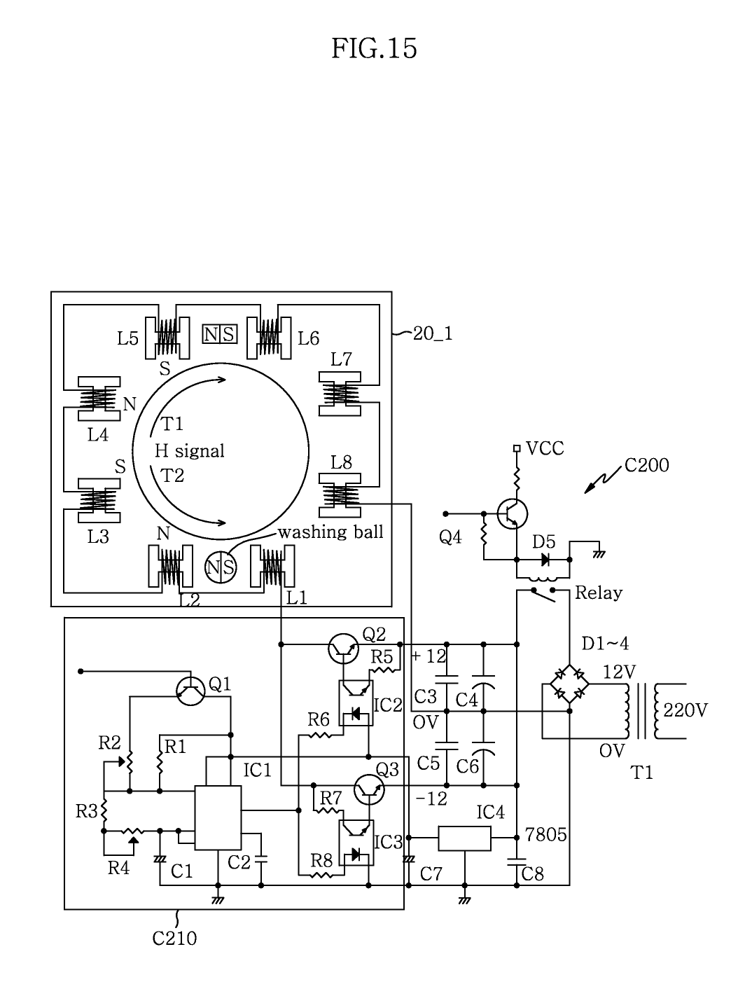

FIG. 15 illustrates an example of a pattern forming circuit C200.

The pattern forming circuit C200 is connected to opposite end wires of the coil windings C20. The part 20_1 of FIG. 15 indicated by a blue color particularly illustrates an example of the coiling windings C20 of FIG. 12, but the present invention is not limited thereto and it is apparent that the indicated part 20_1 may be replaced by the coil windings of FIGS. 13 and 14.

The pattern forming circuit C200 forms a predetermined signal pattern according to a predetermined period or a period determined depending on a rotating direction of a pulsator 13 (or a washing motor), and alternately applies an H signal or an L signal according to the signal pattern to the two end wires of the coil windings C20. Hereinafter, a detailed operation of the pattern forming circuit C200 will be described in detail with reference to FIG. 15.

In FIG. 15, an operation signal (for a clockwise rotation) of the washing motor is applied to B (base) of Q4, a relay RELAY is turned on to apply electric power to the pattern forming circuit C200.

If an initial signal (a clockwise rotation signal of the washing motor) is applied to a transistor Q1 B of the pattern forming circuit C200, an impedance of C1*R1*R2 is formed in a signal generator C210. Accordingly, an H (High) signal is generated at a third terminal of a pulse generator NE555 of the signal generator C210. In the example of FIG. 15, the H signal is generated to have a length of T1.

T1=C1*R1*R2

If the H signal is generated, a signal is applied to a second terminal of a photo coupler IC3 and a transistor Q3 is driven. Accordingly, a current flows through the coil windings C20. If a current flows through the coil windings C20, an electric field is generated around the coil windings C20 according to the Fleming's left hand rule and the washing ball is rotated clockwise by the embedded permanent magnet to be arranged in the electric field and is revolved in a rotating direction (that is, clockwise direction) of the washing motor.

Next, if a time of T1 elapses, an L (Low) signal (pulse) for counterclockwise rotation is generated at a third terminal of the pulse generator NE555. Then, an impedance of C1*(R1+R2)*(R3+R4) is formed in the circuit and the L signal is generated to have a length of T2.

T2=C1*(R1+R2)*(R3+R4)

If the L signal is generated, a driving operation of IC3 is stopped and the photocouplers IC2 and Q2 are driven. Accordingly, a current in an opposite direction flows through the coil windings C20. Thus, an electric field in an opposite direction is generated according to the Fleming's left hand rule, and the washing ball is rotated counterclockwise and is arranged in the changed electric field. Meanwhile, the washing ball is revolved in a direction (that is, the counterclockwise direction) opposite to the rotating direction of the washing motor.

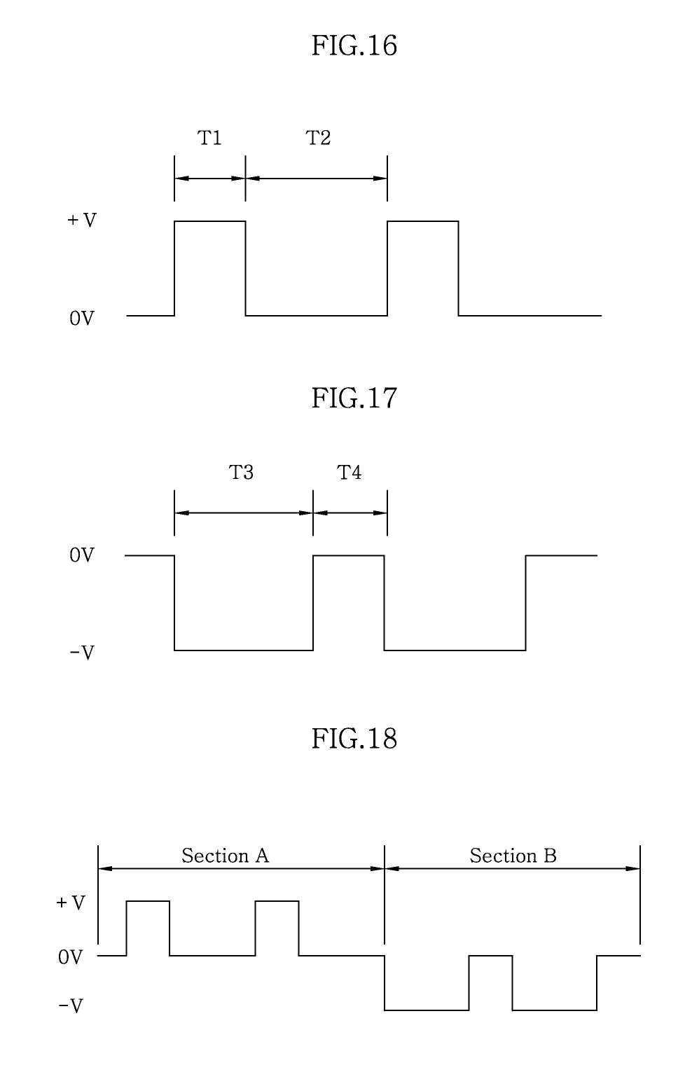

FIG. 16 briefly illustrates a signal pattern according to T1 and T2.

As illustrated in FIG. 16, as the pattern forming circuit C200 of FIG. 15 is designed such that lengths of T1 and T2 are different, when the washing motor is rotated clockwise for a predetermined time, a sum of T1 during rotation of the washing motor is smaller than a sum of T2. Thus, according to a unit signal pattern of FIG. 16, the washing ball repeats clockwise rotation and counterclockwise rotation and revolution, but since the counterclockwise rotation time is longer, the washing ball is rotated and revolved counterclockwise.

Meanwhile, a counterclockwise rotation signal of the washing motor is applied to Q1 B, R2 is neglected. Thus, an H signal having a length of T3 due to an impedance of C1*R1 and an L signal having a length of T4 due to an impedance of C1*R1*(R3+R4) are generated in the pulse forming circuit.

T3=C1*R1

T4=C1*R1*(R3+R4)

FIG. 17 schematically illustrates a waveform of a signal generated to have a magnitude of T3 and T4. As illustrated in FIGS. 17, as T3 and T4 form a pattern substantially opposite to a period pattern of T1 and T2, the washing ball is rotated and revolved in a direction opposite to the prior direction.

Since the washing motor is repeatedly rotated clockwise and counterclockwise as a washing operation is performed, a pattern of the signal generated by the pattern forming circuit C200 is the same as that of FIG. 18. That is, FIG. 18 illustrates that the signal pattern of FIG. 16 and the signal pattern of FIG. 17 are formed successively.

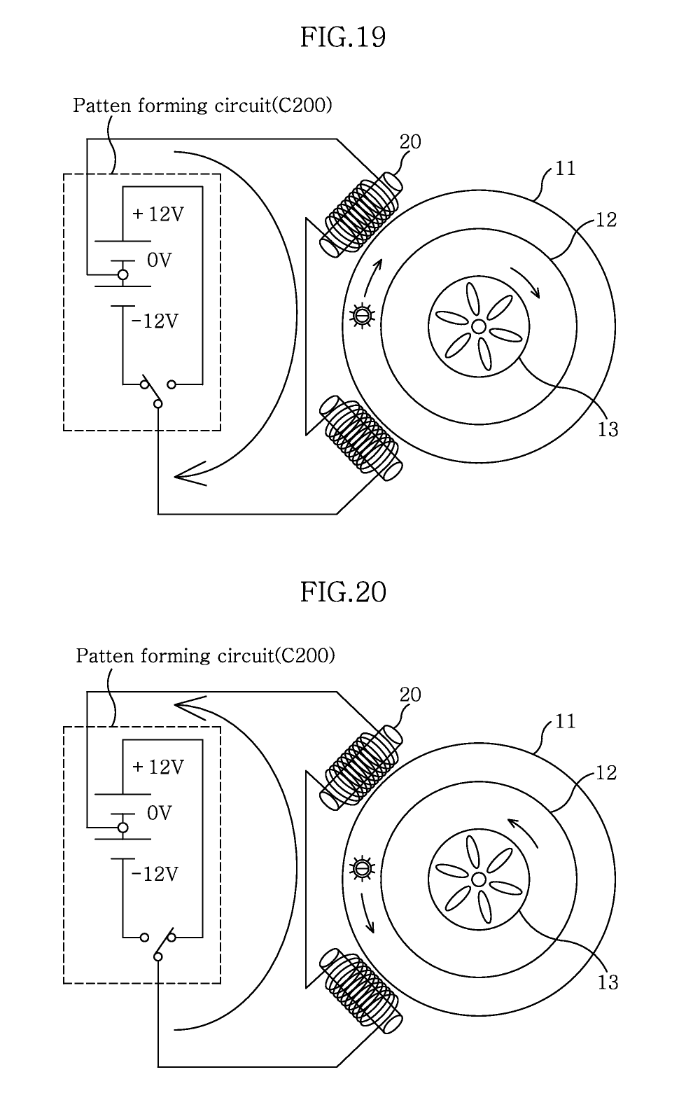

FIG. 19 illustrates that the washing ball in section A where the washing motor of FIG. 18 is rotated clockwise, and FIG. 20 illustrates that the washing ball in section B where the washing motor of FIG. 18 is rotated counterclockwise.

In FIG. 19, if electric power is applied such that the washing motor is rotated clockwise, the pattern forming circuit C200 applies a pattern signal having an H signal having a length of T1 and an L signal having a length of T2 to the coil windings C20. As illustrated in FIG. 18, as T2 is longer than T1 in section A, an electric field due to T2 is formed by a length of T2-T1 between the coil windings C20. Consequently, the washing ball 100 is rotated and revolved in a direction (that is, a clockwise direction) where the washing ball 100 is arranged in the electric field of T2.

In FIG. 20, if electric power is applied such that the washing motor is rotated counterclockwise, the pattern forming circuit C200 applies an H signal having a length of T3 and an L signal having a length of T4 to the coil windings C20. As illustrated in FIG. 18, as T3 is longer than T4 in section B, an electric field due to T3 is formed by a length of T3-T4 between the coil windings C20. Consequently, the washing ball 100 is rotated and revolved in a direction (that is, a counterclockwise direction) where the washing ball 100 is arranged in the electric field of T3.

<Modified Examples of Pattern Forming Circuit>

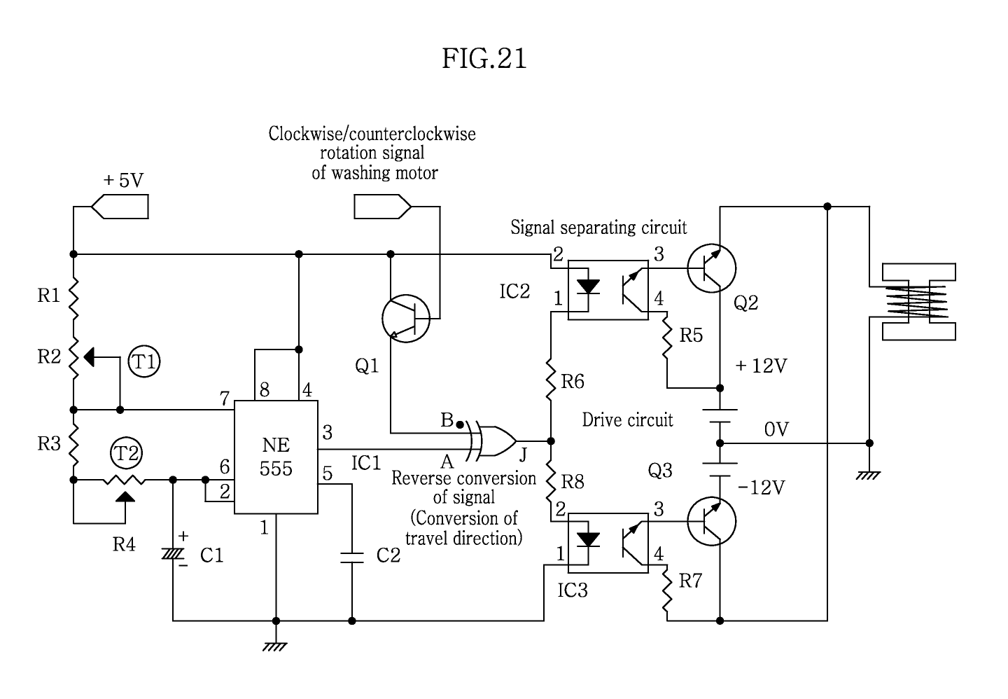

FIG. 21 illustrates a modified example of a signal generator C210 in the pattern forming circuit C200 of FIG. 15, and an overall operation principle of the signal generator C210 is the same as described with reference to FIG. 15.

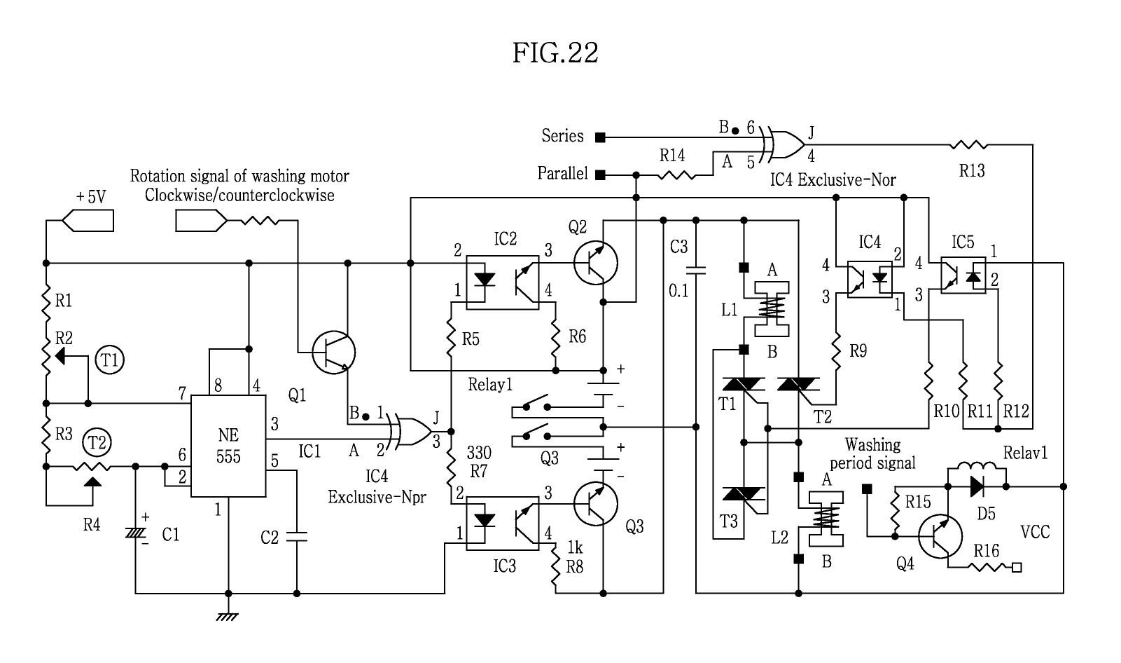

FIG. 22 illustrates another modified example of the pattern forming circuit C200, and illustrates that the washing motor and the pattern forming circuit are simultaneously driven with one power source. The pattern forming circuit of FIG. 22 is not suitable for a device such as a washing machine requiring a high output, but is very useful for a system, such as a set of artificial fish having a permanent magnet and an electronic fish tank (not shown) to which coil windings are mounted instead of a washing ball 100, which requires only a low output. The principle of generating a pattern signal is the same except that one power source is applied, and a repeated description thereof will be omitted.

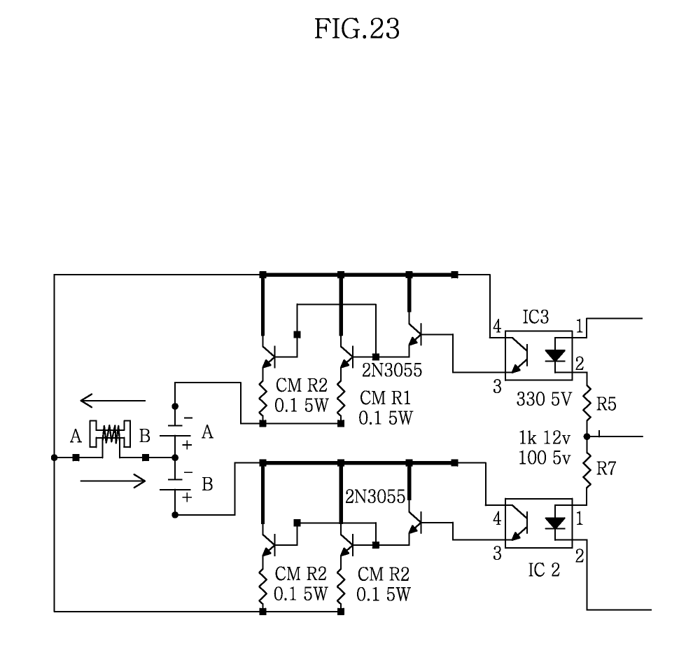

FIG. 23 illustrates another modified example of the pattern forming circuit C200, and illustrates both a high output motor driving circuit using a solid state relay and a pattern forming circuit thereof. The pattern forming circuit of FIG. 23 may be used in a system, such as a dish washing machine, which requires a very high output. The principle of generating a pattern signal is the same except that a solid state relay is added, and a repeated description thereof will be omitted.

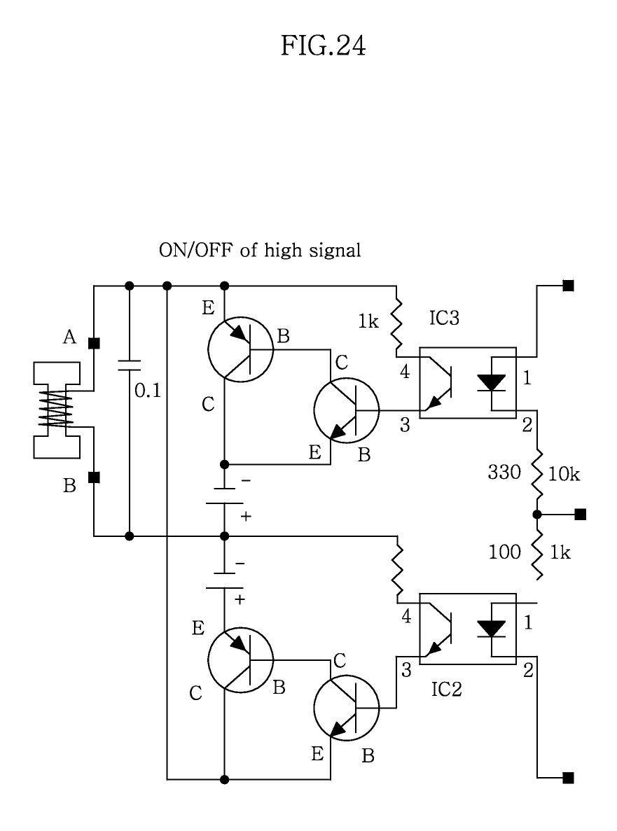

FIG. 24 illustrates another modified example of the pattern forming circuit C200, and illustrates a motor driving circuit for obtaining a high output with a Darlington circuit where a PNP transistor and an NPN transistor are combined and a pattern forming circuit thereof. The principle of forming the pattern forming circuit is the same except that a Darlington circuit is added, and a repeated description thereof will be omitted.

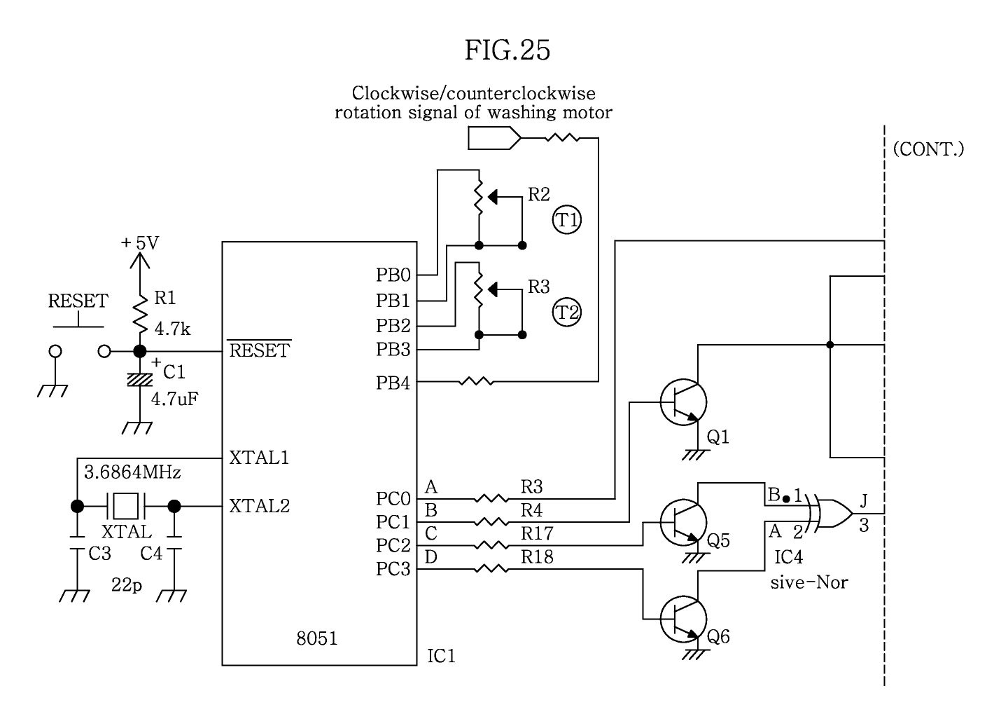

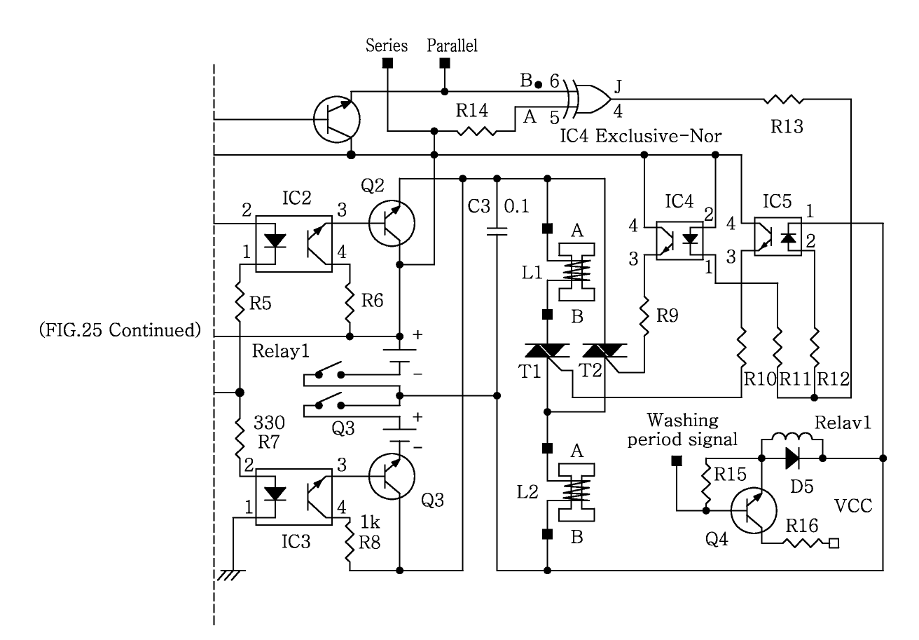

FIG. 25 illustrates another modified example of the pattern forming circuit C200, and illustrates that the control unit 7805 of the pattern forming circuit C200 is replaced by a microcomputer 8051 performing a complex function. The phase and/or amplitude of the pulse signal may be variously modified by using the microcomputer 8051, and thus the movement direction and speed of the washing ball 100 may be regulated. Consequently, this means that a washing force of the washing ball 100 can be regulated more precisely.

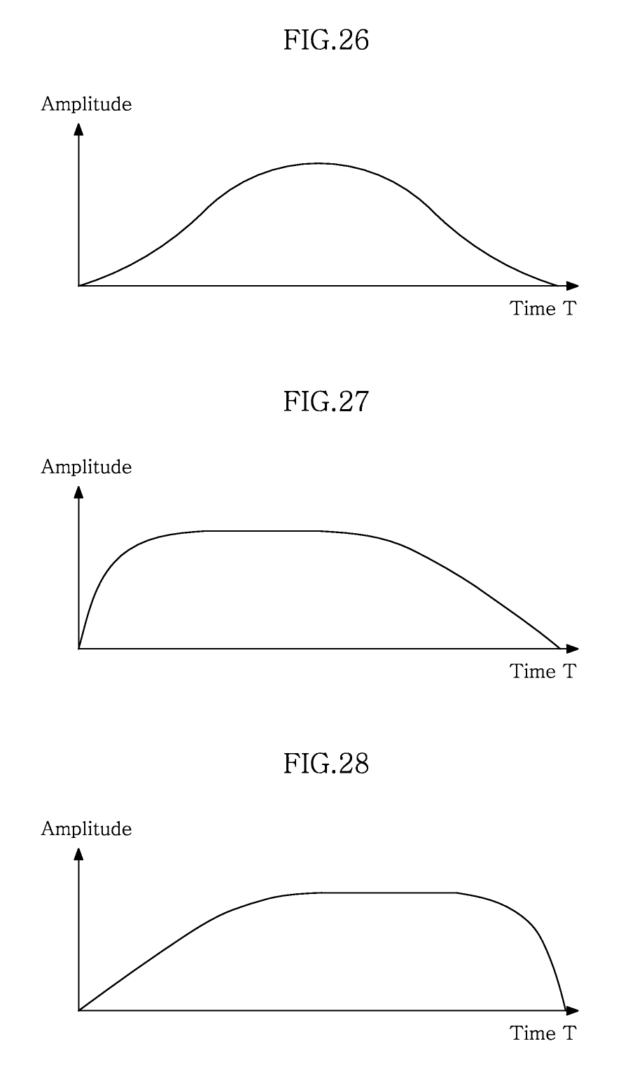

FIGS. 26 to 28 illustrate examples of pulse signals generated by the microcomputer 8051.

FIG. 26 illustrates a general pulse signal generated under the control of the microcomputer 8051. The same or like signal pattern as that of FIG. 18 is generated by the pulse signal of FIG. 26. FIGS. 27 and 28 illustrate that the phase and/or amplitude of the pulse signal of FIG. 26 are modulated. The phase modulation and/or amplitude modulation, the washing ball 100 can be controlled such that the washing ball 100 moved to the bottom of the water tank 11, draw an elliptical locus, or be moved while being attached to the washing tub 13.

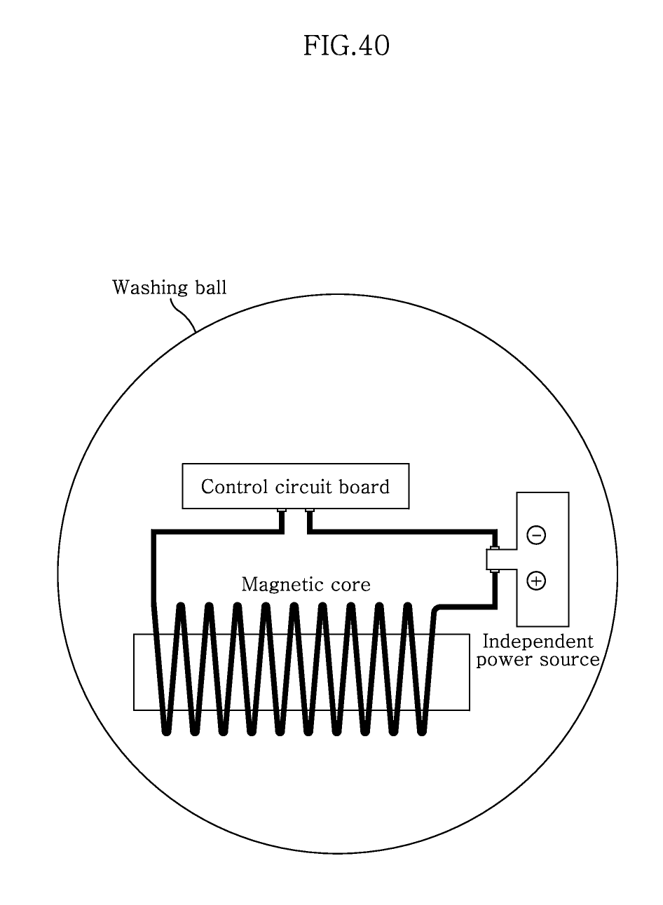

Meanwhile, although it has been described that a plurality of coil windings C20 are disposed on an outer wall of the water container 11 and the washing ball has a permanent magnet therein in the exemplary embodiments, the coil windings may be embedded in the washing ball and a permanent magnet may be disposed on an outer wall of the water container 11. In this case, the washing ball is configured by an independent power source body having the coil windings, the pattern forming circuit and a power source. FIG. 40 briefly illustrates an internal structure of the washing ball configured by an independent power source body. As illustrated in FIG. 40, the washing ball includes a magnetic core corresponding to the coil windings, a control circuit board corresponding to the pattern forming circuit, and an independent power source corresponding to a power source such as a battery. A free movement of the washing ball is induced by a pulse signal output from the pattern forming circuit of the washing ball and an external permanent magnet.

<First Exemplary Embodiment of Drain Cover>

The first exemplary embodiment relates to a drain cover to which the Bernoulli's principle is applied.

In the first exemplary embodiment, a washing ball is the washing ball installed according to Prior Art 1 (Korean Utility Model Application No. 20-2010-0001434) and Prior Art 2 (Korean Patent Application No. 10-2010-0009467).

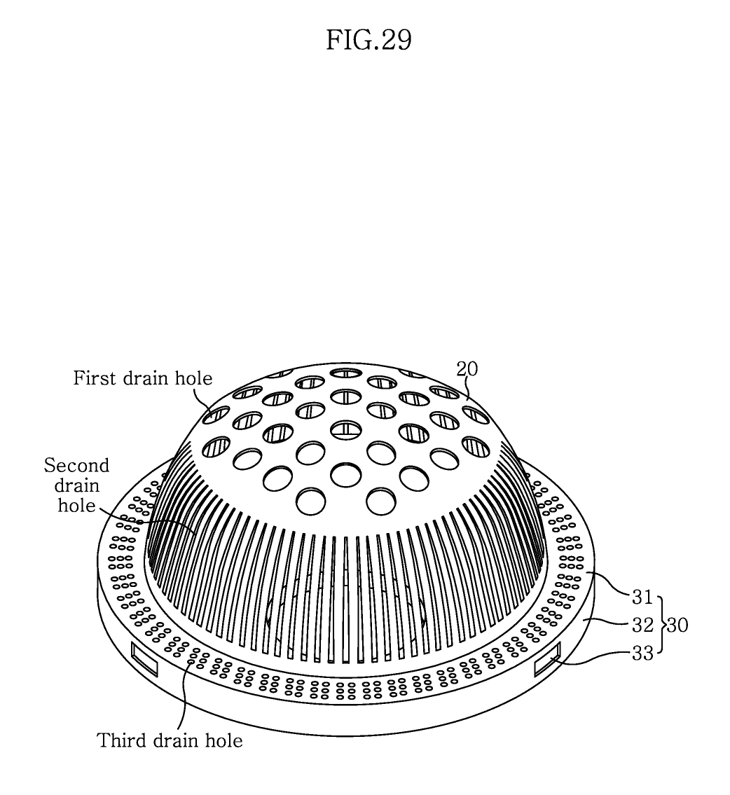

FIG. 29 illustrates an example of a drain cover of the first exemplary embodiment.

The drain cover of the first exemplary embodiment may include a plurality of groups of drain holes whose sizes and shapes are different. Each of the groups of drain holes includes a plurality of drain holes. In the example of FIG. 29, the drain cover includes a convex semispherical main body 20 and a fixing body for stably mounting the body 20 to the drain of the washing machine. Here, the fixing body 30 includes a horizontal circular strip-shaped plate 31 and a vertical circular strip-shaped drain mounting part 32.

The main body 20 includes a first drain hole group having large circular holes and a second drain hole group having a filter member-shaped holes, and a third drain hole group having small circular holes is formed in the plate 31 of the fixing body 30. Here, the third drain hole group is an optional item which can be selectively formed.

A fixing recess 33 for inserting and fixing the drain cover into the drain of the washing machine may be formed on a side surface of the drain mounting part of the fixing body 30, in which case a catching boss (not shown) coupled to the fixing recess 33 may be formed on an inner side of the drain of the washing machine.

When the drain holes pertaining to the first drain hole group are first drain holes, the drain holes pertaining to the second drain hole group are second drain holes, and the drain holes pertaining to the third drain hole group are third drain holes, the area of the first drain holes is largest, the area of the second drain holes is second largest, and the area of the third drain holes is smallest. This is a result obtained by applying the Bernoulli's equation, in which case since less washing balls are concentrated in the drain holes having a large area and more washing balls are concentrated in the drain holes having a small area, a rapid blocking phenomenon of the drain can be lessened.

That is, according to the Bernoulli's equation, if a speed of a fluid increases, an internal pressure of the fluid decreases, whereas if a speed of a fluid decreases, an internal pressure of the fluid increases. In this case, since an internal pressure of the washing water in the first drain holes having a large size is low and an internal pressure of the washing water in the third drain holes having a small size is high, the washing water around the drain flows toward the second drain holes rather than toward the first drain holes, and when the third drain holes are formed, the washing water flows toward the third drain holes rather than the first drain holes or the second drain holes. Thus, since most of the washing balls are influenced by the flow of the washing water and gather toward the third drain holes, the first drain holes and the second drain holes are prevented from being obstructed by the washing balls, making it possible to smoothly drain the washing water.

Meanwhile, a diameter of the drain cover of the first exemplary embodiment is preferably designed to be larger than a diameter of the drain of the washing machine by a predetermined size, and is more preferably designed to be more than twice of the diameter of the drain. This is because a sufficient discharged water introducing space can be secured even if some drain holes are blocked when the washing balls are stuck to the drain cover.

Although FIG. 29 illustrates a drain cover having a convex main body 20, a drain cover having a concave main body 20 can be used as a modified example of the present invention.

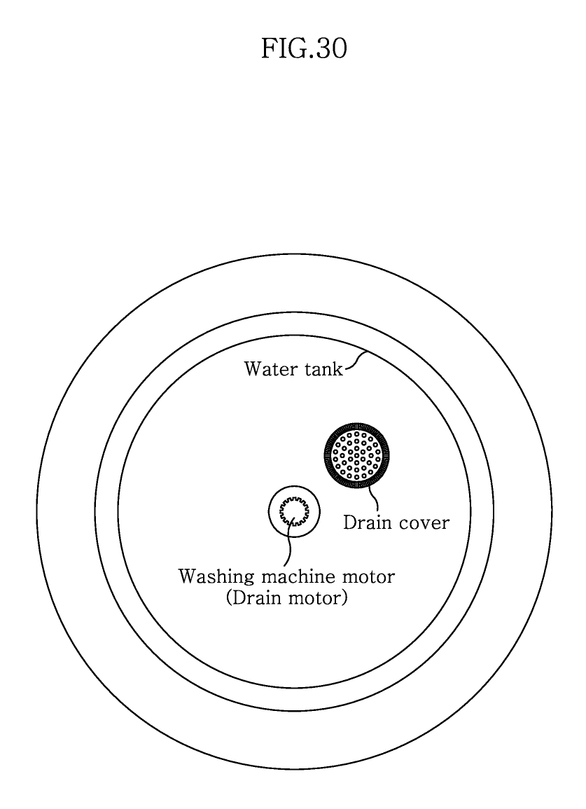

FIG. 30 illustrates that the drain cover of the first exemplary embodiment is mounted to the drain of the washing machine. As illustrated in FIG. 30, a motor (or a drain motor) of the washing machine is mounted to the center of the water tank of the washing machine, and the drain cover of the first exemplary embodiment is mounted to a predetermined location around the drain cover.

<Second Exemplary Embodiment of Drain Cover>

The second exemplary embodiment relates to a drain cover of the second exemplary embodiment.

In the following examples, the washing ball particularly is a washing ball installed in Prior Art 2 (Korean Patent Application No. 10-2010-0009467).

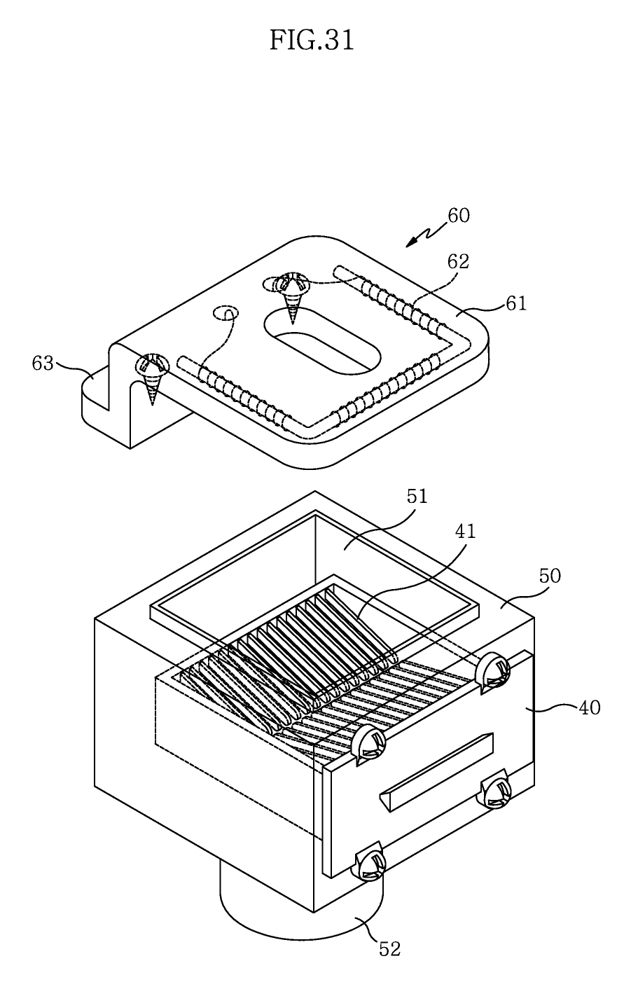

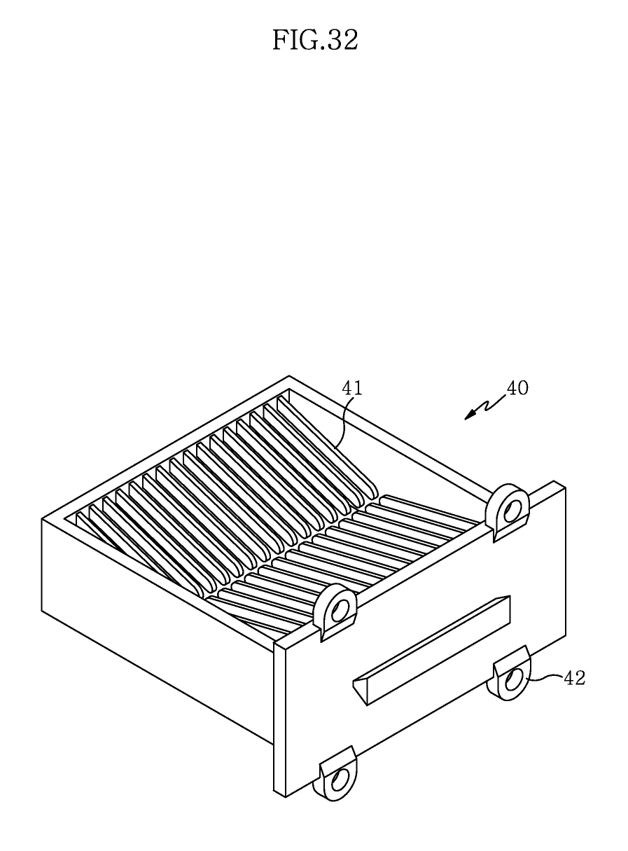

FIG. 31 illustrates an example of a drain cover of the second exemplary embodiment.

As illustrated in FIG. 31, the drain cover of the second exemplary embodiment includes a filter frame 40 including filter members for filtering washing balls and a receiving body 50 for receiving the filter frame 40 and fixing the filter frame 40 to a location of the drain of the washing machine.

FIG. 32 separately illustrates a filter frame 40 to help understanding of the filter frame 40.

The filter frame 40 may be formed in the form of a rectangular box whose upper and lower surfaces are opened, and as in the example of FIG. 32, may be formed in the form of a rectangular drawer. When the filter frame 40 is formed in the form of a rectangular drawer, at least one fixing member 42 for fixing the filter frame 40 to the receiving body 50 with a piece may be installed on a side surface thereof corresponding to the knob portion of the drawer.

Meanwhile, according to the above-structured filter frame 40, thin and long foreign substances such as hair and threads can be smoothly discharged. In general, in the case of a grid type filter net for filtering foreign substances, thin and long foreign substances are entangled at a point where filtering portions cross and this phenomenon becomes severe, which makes it difficult to smoothly discharge the foreign substances. Meanwhile, since two filter members 41 having an inclined comb shape at a predetermined angle are formed to face each other in the filter frame 40 of the present invention and a spaced gap is formed between the two filter members 41, even when hair or threads are entangled in the filter portions, as the hair or threads descend along the filtering portions due to the inclination of the filtering portions and the discharge of the hair or threads, the drain is prevented from being blocked by the hair or threads.

Since the filter member 41 has a structure where the peripheries of the filtering portions are formed by one closed curve, the thin and long foreign substances can be smoothly discharged, whereas in the case of the grid type filter net, the thin and long foreign substances are entangled due to its apexes.

Meanwhile, the spaced gap formed between the two filter members 41 preferably has a sufficient distance such that coins or buttons can be discharged therefrom.

A receiving recess (not shown) for receiving the filter frame 40 is formed on one side surface of the receiving body 50, and a drain inlet 50 is formed on an upper surface thereof to receive washing water. FIG. 31 exemplifies a drain inlet 51 having a rectangular shape, but the present invention is not necessarily limited thereto and the drain inlet 51 may be formed to have a polygonal or circular shape in addition to a rectangular shape. A drain outlet 52 protruding to have a pipe shape is formed on a lower surface of the receiving body 50 to couple and fix the receiving body 50 to the drain of the washing machine. When the drain outlet 52 is inserted and coupled into the drain of the washing machine, a diameter of the drain outlet 52 may be preferably designed to be smaller than the diameter of the drain of the washing machine.

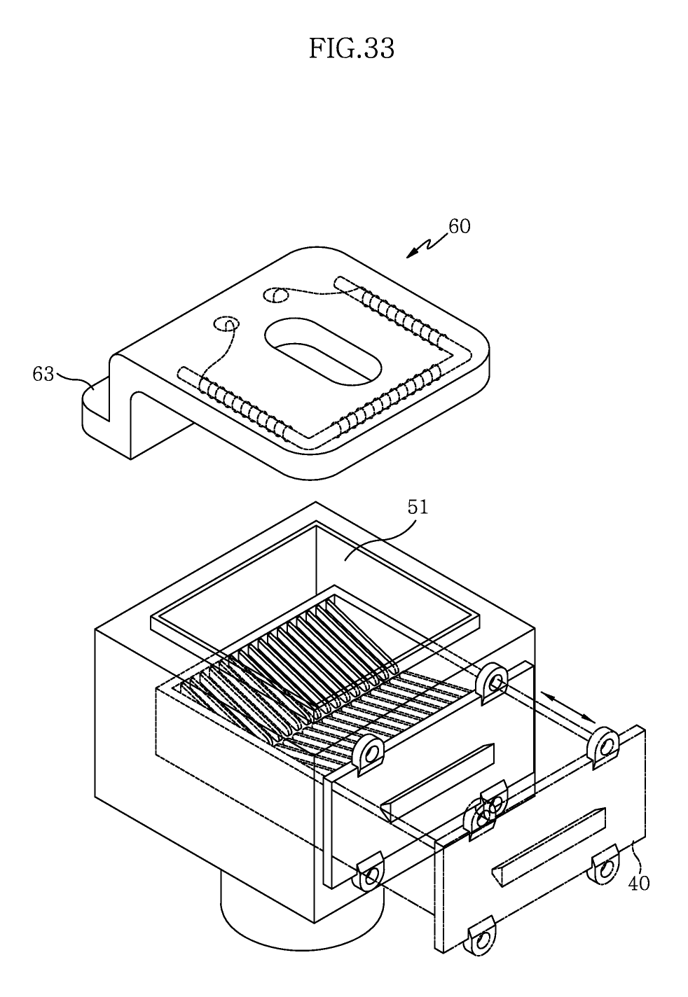

As time elapses, various washing foreign substances are accumulated in the filter frame 40, and if discharging efficiency lowers, the filter frame 40 can be separated from the receiving body 50 to remove the foreign substances. Then, since the filter frame 40 can be received by the receiving body 50, maintenance costs can be reduced and management can be easily carried out. FIG. 33 illustrates that the filter frame 40 is received by the receiving body 50 to help easy understanding thereof.

Meanwhile, in a process of discharging washing water, a plurality of washing balls gather in a space between the receiving body 50 of the drain cover and the filter frame 40. In this case, as illustrated in FIG. 31, since the space is recessed, the washing balls cannot be naturally withdrawn from the space even when water is supplied unless the washing balls are artificially pulled out.

In order to solve the problem, the drain cover of the second exemplary embodiment may further include a magnetic body inducing unit 60 located at an end of the receiving body 50 to pull out the washing balls from the space by using a solenoid coil. Since the washing ball of Prior Art 2 has a magnetic body (for example, a permanent magnet) at the center thereof, the washing ball can be attracted by an electric field formed by the solenoid coil and easily escaped from the receiving body 50.

The magnetic body inducing unit 60 is located at an upper portion of the receiving body 50 while maintaining a distance sufficient such that the washing balls can be easily withdrawn from the receiving body 50. The magnetic body inducing unit 60 includes a frame 62 having a solenoid coil 61 therein and a bracket 63 for fixing the frame 62 to a predetermined location (for example, a bottom plane of the water tank of the washing machine and one end of the drain motor of the washing machine) of the washing machine. The frame 62 and the bracket 63 may be integrally formed.

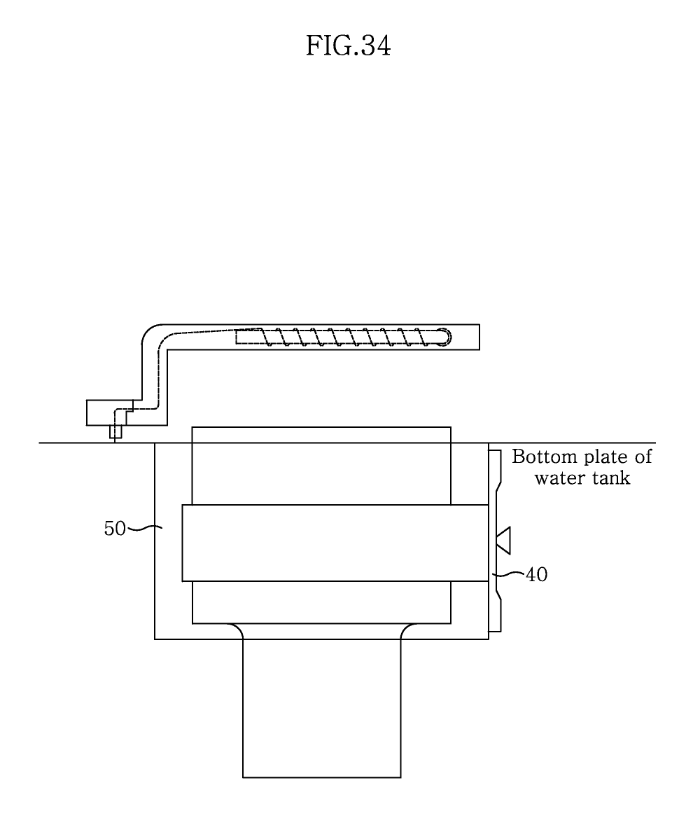

FIG. 34 is a side view for expressing a structure where a drain cover of the second exemplary embodiment is mounted to the washing machine.

In the example of FIG. 34, it can be seen that the receiving body 50 is mounted to a lower portion of the bottom plate of the water tank and the magnetic body inducing unit 60 is fixedly mounted to a bottom plate of the water tank while being spaced apart from the receiving body 50 by a predetermined distance.

Since it is necessary to operate the solenoid coil 61 only in the draining process in an aspect of saving energy, the solenoid coil 61 is preferably designed to be moved in conjunction with a drive part (not shown) of the drain motor of the washing machine.

It is necessary to form an electric field sized such that the washing balls can float only to escape from the receiving body 50 when a driving voltage is applied to the solenoid coil 61. To this end, the number of windings of the solenoid coil 61 is regulated or a separate driving voltage dropping (or rising) circuit may be further provided in the magnetic body inducing unit 60 to form a proper strength of electric field.

Meanwhile, it is necessary to block the washing balls from being introduced into the recessed space before the washing balls introduced into the recessed space of the drain cover are pulled out with the magnetic body inducing unit 60. To this end, a blocking step having a plurality of boss plates may be further formed around the drain cover of the second exemplary embodiment.

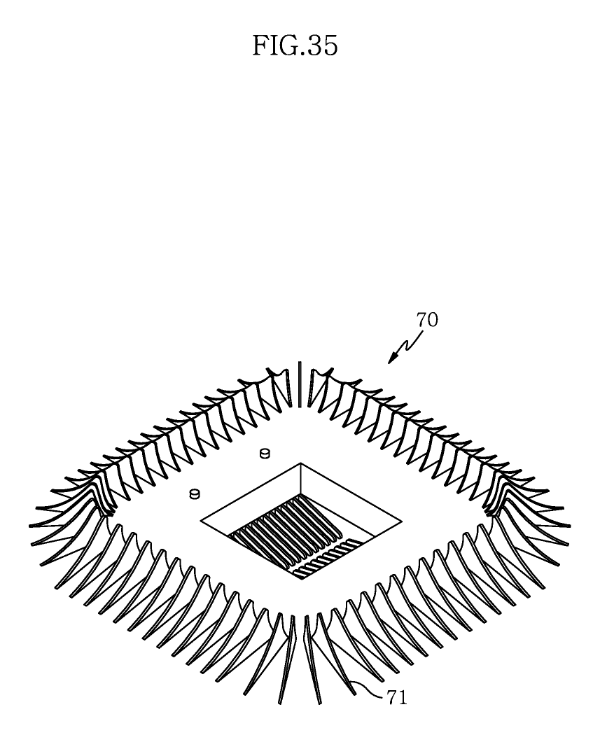

FIG. 35 illustrates that the blocking step 70 is formed around the drain cover.

As can be seen from the example of FIG. 35, the blocking step is formed to have a substantially rectangular shape so as to surround the drain cover while a plurality of triangular plates 71 maintain a predetermined interval. This is because drain time cannot be delayed in spite of existence of the blocking step 70 as the washing water passes through the spaces between the triangular plates 71. As the washing balls are induced toward the triangular plates 71 of the blocking step 70 rather than directly go beyond the blocking step 70 by the Bernoulli's principle, the washing balls can be blocked from being introduced into the recessed space primarily. Here, it is unnecessary to realize the triangular plates 71 with exact triangles, but the triangular plates 71 can be realized by fin shapes of sharks.

<Third Exemplary Embodiment of Drain Cover>

The third exemplary embodiment of the drain cover relates to a drain cover where an inclination of a filter member is formed by a resilient means.

While in the second exemplary embodiment of the drain cover, a filter member 41 is fixed to an inner side of the filter frame 40 at a predetermined angle, the filter frame 4000-1 of the third exemplary embodiment is instantaneously inclined by a predetermined angle due to its weight while the filter member 4100-1 normally maintains a horizontal state if foreign substances such as washing balls reaches the filter frame 4000-1, and returns to the horizontal state due to a resilient member if the foreign substances are removed.

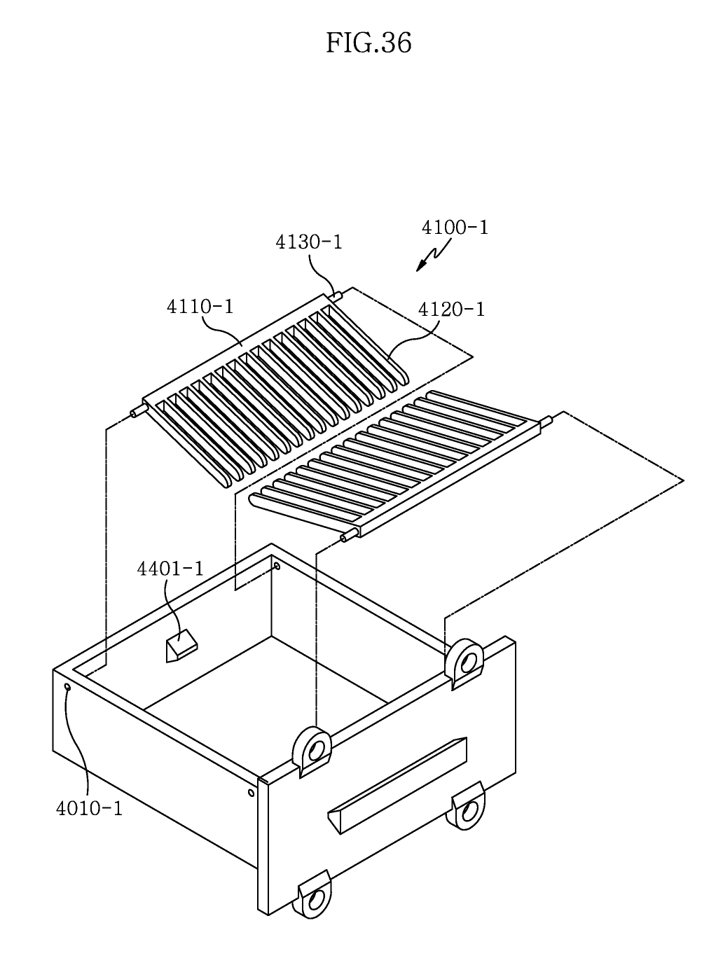

FIG. 36 illustrates an example of a filter frame 4000-1 according to the third exemplary embodiment of the drain cover.

According to an example of FIG. 36, two filter member 4100-1 form a pair, and each of the filter members 4100-1 has a body 4110-1 and a plurality of filtering portions 4120-1. Coupling bosses 4130-1 for coupling the filter member 4100-1 to the filter frame 4000-1 are formed on opposite side surfaces of the body 4110-1, and four coupling recesses 4010-1 coupled to the coupling bosses 4130-1 of the filter member 4100-1 are formed on an inner side of the filter frame 4000-1.

In addition, the filter frame 4000-1 of FIG. 36 may further include a resilient member (not shown in FIG. 36) for providing a resilient force to the filter member 4100-1 such that the filter member 4100-1 is normally supported to maintain a horizontal state, and the filter member 4100-1 is inclined downward if an object having a weight is positioned on the filter member 4100-1 and recovers a horizontal state if the object is removed from the filter member 4100-1. An example of the resilient member 4100-1 may include an A-shaped spring or a ring-shaped plate spring. To this end, a fixing recess (not shown) to which one end of the spring is fixed may be formed on the inner side of the filter frame 4000-1.

One of the objects positioned on the filter member 4100-1 may be a washing ball. However, it is necessary to design the filter member 4100-1 such that the filter member 4100-1 is inclined due to the weight of the washing ball but the washing ball does not pass through the drain cover. To this end, a stopper 4400-1 for stopping an inclined movement of the filter member 4100-1 and preventing the filter member 4100 from being further inclined from a predetermined angle may be further formed in the body 4110-1 of the filter member 4100-1 or on an inner side surface of the filter frame 4000-1 contacting the body of the filter member 4100-1 lengthwise. The shape and location of the stopper 4400-1 are not limited, and may be formed simply to have a boss or triangular protrusion shape as an example.

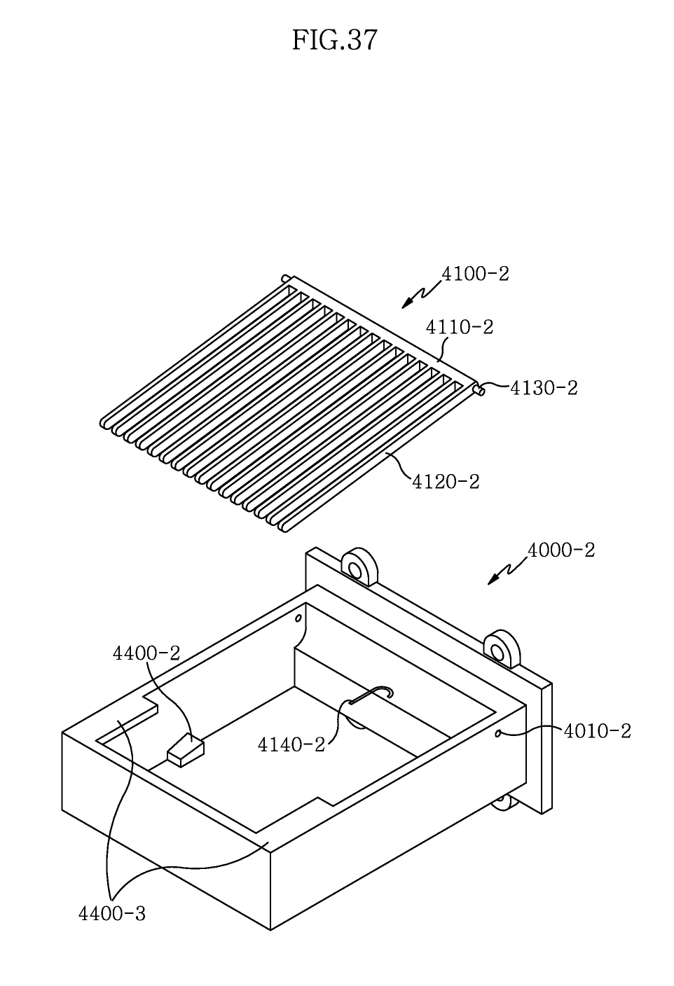

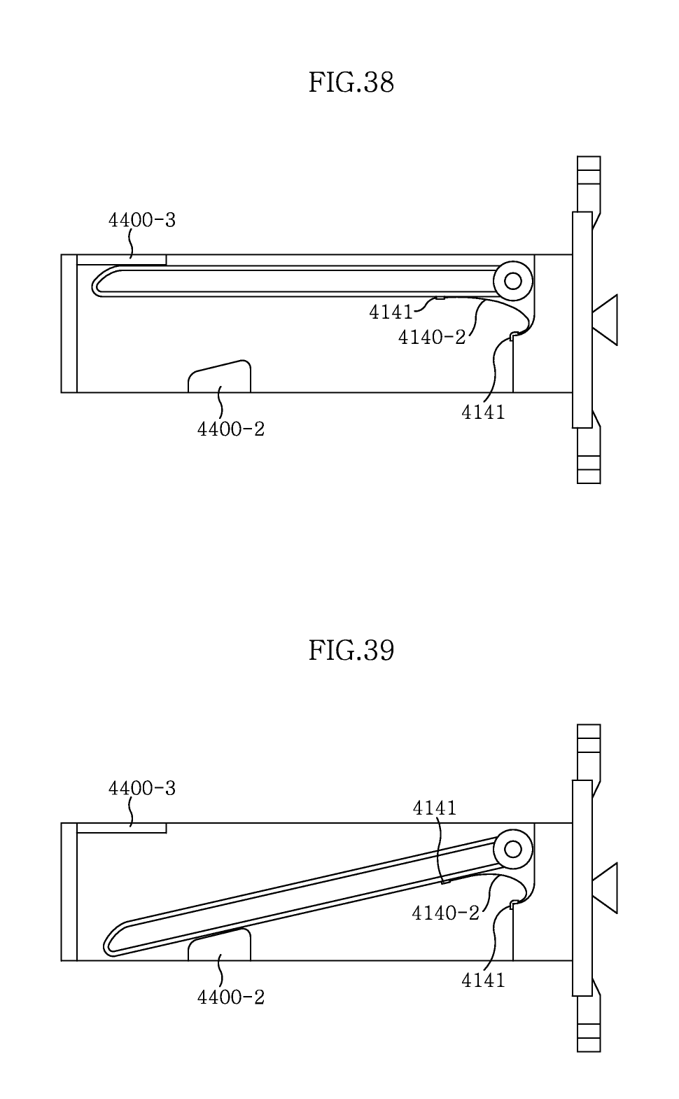

FIG. 37 illustrates another example of the filter frame 4000-2 according to the third exemplary embodiment, and FIGS. 38 and 39 are side views for explaining the operation principle of the filter frame 4000-2.

According to an example of FIG. 37, one filter member 4100-2 is provided in the filter frame 4000-2, and each filter member 4100-2 has a body 4110-2 and a plurality of filtering portions 4120-2. Coupling bosses 4130-2 for coupling the filter member 4100-2 to the filter frame 4000-2 are formed on opposite side surfaces of the body 4110-2, and two coupling recesses 4010-2 coupled to the coupling bosses 4130-2 of the filter member 4100-2 are formed on the inner side of the filter frame 4000-2.

In addition, the filter frame 4000-2 of FIG. 37 may further include a resilient member (not shown in FIG. 36) for providing a resilient force to the filter member 4100-2 such that the filter member 4100-2 is normally supported to maintain a horizontal state, and the filter member 4100-2 is inclined downward if an object having a weight is positioned on the filter member 4100-2 and recovers a horizontal state if the object is removed from the filter member 4100-2. An example of the resilient member 4140-2 may include an A-shaped spring or a ring-shaped plate spring. As illustrated in FIGS. 38 and 39, a spring catching step 4141 to which one end of the spring is fixed may be formed on an inner side of the filter 4000-2 and on a lower side of the filter member 4100-2.

A lower stopper 4400-2 for stopping an inclined movement of the filter member 4100-2 at a predetermined angle and preventing the filter member 4100-2 from being further inclined may be further formed on an inner side surface of the filter frame 4000-2. An upper stopper 4400-3 for blocking the filtering portion 4120-2 of the filter member 4100-2 from further protruding upward due to the resilient member 4140-2 may be formed at an upper portion of the filter frame 4000-2. It is preferable that the lower stopper 4400-2 protrudes to have an inclined rectangular shape and the upper stopper 4400-3 is formed on opposite sides of an upper portion of the filter frame 4000-2 to have a plate shape, but they are not limited to the specific shapes.

Meanwhile, any member capable of applying a resilient force to the filter members 4100-1 and 4100-2 may be used as the resilient member (not shown in FIGS. 36 and 4140-2 of FIG. 37), and the fixing recesses (not shown in FIG. 36 and the spring catching step 4141 of FIGS. 38 and 39) for fixing the resilient member need to be corrected according to the characteristics of the resilient member. Since the correction of the fixing recesses is well known in the art to which a backward flow preventing drain cover, those skilled in the art can easily modify the design of the fixing recesses.

The configurations of the receiving body 50, the magnetic body inducing unit 60, and the blocking step 70 are the same as those of the second exemplary embodiment of the drain cover except for the filter frame 4000-1 and 4000-2 in the third exemplary embodiment.

The drain covers according to the exemplary embodiments of the present invention may be applied to a drain of a drum washing machine as well as a general washing machine of FIG. 1 and is not limited thereto.

Although the exemplary embodiments of the present invention have been described in detail, the scope of the present invention is not limited thereto but various modifications and improvements made by those skilled in the art using the basic concept of the present invention defined by the following claims fall within the scope of the present invention.

The exemplary embodiments of the present invention can be applied to the field of washing an interior of a washing machine.

1. An induction apparatus for a floating body provided therein with a permanent magnet and located in a water container, the induction apparatus comprising:
a plurality of coil windings mounted to an outer surface of the water container; and
a pattern forming circuit for applying a pulse signal of a predetermined pattern to the coil windings to generate an electric field for inducing the floating body within the water container.

2. The induction apparatus of claim 1, wherein the induction apparatus is mounted to a washing machine and the pattern forming circuit generates pulse signals having patterns different from each other according to a rotating direction of a washing motor of the washing machine.

3. The induction apparatus of claim 2, wherein, if a driving signal in a first rotating direction of the washing motor is applied to the pattern forming circuit, a pulse signal having a first pattern where durations of a high (H) signal and a low (L) signal are different from each other is applied to the coil windings.

4. The induction apparatus of claim 3, wherein, if a driving signal in a second rotating direction of the washing motor is applied to the pattern forming circuit, a pulse signal having a second pattern where durations of a high (H) signal and a low (L) signal are different from each other is applied to the coil windings.

5. The induction apparatus of claim 4, wherein the H signal and the L signal have a certain plus value and a zero value, respectively, in the pulse signal of the first pattern and the H signal and the L signal have a zero value and a certain minus value, respectively, in the pulse signal of the second pattern.

6. The induction apparatus of claim 5, wherein the floating body is induced by an electric field generated by one of the H signal and the L signal, which has a longer duration in the pulse signal of the first pattern, such that the floating body is rotated and revolved in the first rotating direction and is induced by an electric field generated by one of the H signal and the L signal, which has a longer duration in the pulse signal of the second pattern, such that the floating body is rotated and revolved in the second rotating direction.

7. The induction apparatus of claim 1, wherein the pattern forming circuit modulates at least one of a phase and an amplitude of the pulse signal to change the electric field generating pattern.

8. The induction apparatus of claim 1, wherein the floating body is a washing ball for a washing machine, which is inserted between the washing tub and the water container of the washing machine, and the washing ball includes a body having a permanent magnet therein to maintain a predetermined buoyancy so as to be located at a predetermined depth of the water container, and a plurality of projections attached to an outer side of the body to frictionally make contact with an inner wall of the water container in order to remove filth.

9-21. (canceled)
